(19) United States
(12) Patent Application Publication
(10) Pub. No.: US 2013/0193201 A1
(43) Pub. Date: Aug. 1, 2013

(54) SYSTEM AND METHOD FOR ACCESSING PRODUCT INFORMATION FOR AN INFORMED RESPONSE

(71) Applicant: Augme Technologies, Inc., New York, NY (US)

(72) Inventors: Nathaniel T. Bradley, Tucson, AZ (US); Jim G. Crawford, Fall City, WA (US); Joshua S. Paugh, Tucson, AZ (US); Douglas F. Bender, Scotts Valley, CA (US)

(73) Assignee: Augme Technologies, Inc., New York, NY (US)

(21) Appl. No.: 13/717,066

(22) Filed: Dec. 17, 2012

Related U.S. Application Data
(60) Provisional application No. 61/591,131, filed on Jan. 26, 2012.

(51) Int. Cl. G06F 17/30

(52) U.S. Cl. CPC G06F 17/30002; G06Q 30/0623
USPC 235/375; 705/26.61

(57) ABSTRACT

A system and method that permits a person to gain information regarding one or more products by capturing data in the form of a scan or image capture to the data capture device, identifying the product, and delivering to the person information relevant to the product.

### CROSS-REFERENCE TO RELATED APPLICATIONS

The claims priority to U.S. Provisional Application Ser. No. 61/591,131, filed Jan. 26, 2012, which is hereby incorporated in its entirety by reference.

The present invention is related to co-pending, commonly assigned U.S. Patent Application Publication No. 2011/0264527A, which is hereby incorporated in its entirety by reference.

### BACKGROUND OF THE INVENTION

The present invention relates generally to systems and methods of accessing product information. More specifically, the present invention provides a system and method that permits a person to gain information regarding one or more products by capturing data in the form of a scan or image capture to the data capture device, identifying the product, and delivering to the person information relevant to the product.

The product information an individual may require when making a purchase decision can be varied and unpredictable. Due to limitations in printing space, all pertinent information is often not feasibly included with a product. Accordingly, information supplemental to that included with the product itself can be necessary for the individual to make an informed decision. Accordingly, ready access to such information is desirable. However, access to all the information regarding a product, depending on the format of said information, may make extracting the information needed by the individual difficult and cumbersome. As such, there is a need for increased access to product information tailored to the needs of an individual.

A person making a purchasing decision may be considering two or more products. Similarly, the person may require additional product information about each of the products to make an informed purchase decision. Moreover, the person may have unique preferences or needs that inform his or her purchase decision. Accordingly, mere access to product information for each of the products requires the person to engage in a cumbersome comparison of each of the products. Moreover, existing comparative analysis tools for comparing products are often limited to the products included within the catalog of an individual retailer. Comparing products not carried by a single retailer is impossible with such a comparative analysis tool. Finally, as noted above, access to all product information alone does not completely address the problem; individuals may have to review copious amounts of product information to locate the information relevant to their purchase decision. Accordingly, there is a need for a method of comparing products that accounts for an individual's needs and preferences.

A person having already purchased one or more products often wishes to learn of other products that can be used in conjunction with the already purchased products, such as ingredients in a recipe. However, current product list suggestion tools require the input of individual parts selected from pre-determined lists via a personal computer. Decisions of this nature are often made in-store or otherwise away from a personal computer. Accordingly, there is a need for a product list suggestion tool that allows for increased ease of use away from a personal computer.

### SUMMARY OF THE INVENTION

It is an objective of the invention, therefore, to provide a more personalized and convenient method of accessing product information. The method of data capture may include, but is not limited to, optical image capture. The image captured may include machine-readable medium such as a barcode, which may take the form of linear barcodes, matrix barcodes, or three-dimensional barcodes. The image captured may also include text that is identifiable. The user may select a domain of interest to accompany the data captured. And the user may then optionally data capture additional data or images to accompany the domain of interest.

The data captured is then sent to a code triggered information server that performs a variety of tasks. First, the server identifies one or more products associated with the data capture. Second, depending on the instructions received from the user and the domain of interest selected, the server will access product information associated with at least one of the one or more products associated with the data capture. The product information or store is a database acting as a repository for such information and is readily accessible by the server. The server then accesses information about the user from a user profile located in a user profile database. Once the needed information about both the one or more products and the user has been acquired, the server will generate a Response Message or Informed Response to be sent to the user. The content of the Response Message is determined by the product information gathered, the user information gathered, domain of interest selected, and the instructions received from the user.

The product information delivered to the user is determined by the user via an instruction in a computer program, and may include health information, such as the presence of allergens or undesirable ingredients in the one or more products of the data capture, or drug interactions. The product information may also be a comparative analysis between two or more products identified within the data capture, based upon information accessible about each product, as well as preferences indicated by the user profile. Furthermore, the product information may include a list of one or more products that the user may consider when making a purchasing decision. The list of items may be combined with one or more products the user already possesses. Product information may be accessed by associated databases, product databases, internet search, and third party databases.

These and other aspects, objectives, features and advantages of the present invention will be described hereinafter with reference to embodiment of the invention. Generally, the system of the present invention employs a Code Triggered Information Server (“CTIS”) and a CTIS Database.

Content providers, such as providers of services, print content, display content, electronic content, video content, musical content, retailers, wholesalers, web-site providers, mercantile product providers, industrial product providers, or virtually any other type of commercial, informational, educational or service provider, will participate in providing content (generally and broadly referred to herein by the term “Informed Response”) for ultimate dissemination to users. The CTIS Server stores the Informed Response from the content providers and delivers the Informed Response to users based upon users registering interest in a particular artifact of interest to the user. The Informed Response may be stored on the CTIS server itself, storage directly coupled to the CTIS server or on third party servers referenced by the CTIS server.

Users may register for access to the CTIS via the internet, telephone, postal mail, and/or the like. If a particular embodiment of the CTIS requires client software for the user to install, this could be supplied upon successful user registration. In an alternative embodiment, a basic user identification packet (e.g., a “cookie”) is sent with a user's first code scan, thus establishing a basic user profile that can be filled in with greater detail at a later time.

The functionality of the CTIS and its operation and cooperation with the CTIS Database will be described in greater detail hereinafter. However, generally, the CTIS Database, which may be centralized or distributed, may be proprietary or may be an open database capable of operating across multiple database sites on the Internet, in the Cloud or across various search engines, to look up data either residing with the CTIS Database or retrieve the data from external sources and incorporate the data into the CTIS Database. The CTIS Server, therefore, acts as a type of gateway between artifacts captured by the user and Ads in the CTIS Database to be distributed to the user based upon the user captured artifacts.

Artifacts capable of being capture include, among other things, 3D barcodes that are have regions of differing heights, with the regions, their patterns and their relative heights being representative of data. In accordance with one embodiment of the present invention, the three dimensional nature of artifacts, including barcodes, may be used advantageously for allowing sight or hearing impaired individuals to capture data from artifacts with 3D codes, whether 3D barcodes per se, or other 3D surfaces capable of acting as data sources, and have that data captured, processed and provided to such individuals in a form that makes the information encoded by the 3D data more available to the user. In one particular embodiment, sight impaired individuals often employ their haptic senses to, for example, read using braille, to scan products to identify container shapes or features or the like. These skills are, of course, learned and require considerable effort on the part of the individual. The present invention may be used with sight impaired individuals to capture sensory data otherwise unavailable or difficult to access to such individuals and convert the sensory data into a usable form, e.g., sounds. Similarly, in accordance with another embodiment of the invention, a hearing impaired individual may use the present invention to capture audible sensory data, e.g., music, street sounds, warning sounds or the like, and covert such unavailable or difficult to access sensory data in a form, e.g., visual, that renders such audible sensory data more available and meaningful to a hearing impaired individual. In this manner, the present invention may be employed to simply capture and convert data existent in one sensory form to another sensory form that is more useful or available to a user having a particular disability or impairment.

### BRIEF DESCRIPTION OF THE DRAWINGS

FIG. 1 shows the combined logic and data flow block diagram illustrating a general overview of embodiments of the GCSI/CTIS.

FIG. 2 shows the combined logic and data flow block diagram illustrating a general overview of embodiments of the GCSI/CTIS.

FIG. 3 shows a particular exemplary embodiment of the GCSI/CTIS, wherein contextual information and advertising is served to the user.

FIG. 4 shows an embodiment of the web interface for user registration.

FIG. 5 shows several 2D barcodes that may be employed within the GCSI/CTIS.

FIG. 6 shows an illustration of one embodiment of the Scan Message data structure.

FIG. 7a shows an illustration of one embodiment of a user profile data structure.

FIG. 7b shows an illustration of an implementation of a user profile user interface in one embodiment of GCSI/CTIS operation.

FIG. 8 shows an illustration of one embodiment of the Information Base (Informed response) data structure.

FIG. 9 shows an example of coupons provided by the GCSI/CTIS.

FIG. 10 shows an example of coupons provided by the GCSI/CTIS.

FIG. 11 shows an implementation of a user interface manifesting GCSI/CTIS functionality on a portable electronic device in one embodiment of GCSI/CTIS operation.

FIG. 12 shows an implementation of a user interface manifesting GCSI/CTIS functionality for serving a short messaging service text message prompt in one embodiment of GCSI/CTIS operation;

FIG. 13 shows an implementation of a user interface manifesting GCSI/CTIS functionality on a mobile phone in one embodiment of GCSI/CTIS operation;

FIG. 14 shows an implementation of a user interface manifesting GCSI/CTIS functionality on a portable communication device in one embodiment of GCSI/CTIS operation;

FIG. 15 shows a computer systemization of the GCSI/CTIS.

FIG. 16 shows a combined logic and data flow block diagram for a particular exemplary embodiment of a system

FIG. 17 shows a combined logic and data flow block diagram for a particular exemplary embodiment of a system.

FIG. 18 shows a combined logic and data flow block diagram for a particular exemplary embodiment of a system.

### DETAILED DESCRIPTION OF THE INVENTION DEFINITIONS & TERMINOLOGY

The following terms, whether in their singular or plural form, and whether juxtaposed by another antecedent or subsequent term, are intended to have the following meanings in addition to their commonly understood meanings to those of ordinary skill in the art as of the filing date hereof. For example, the combination of two terms, such as “computer” and “server,” into the single term “computer server” is intended to have a meaning consistent with the meanings of the individual terms “computer” and “server.”

### “Server,” “Computer”, “Client”, “Network”, “Router”

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

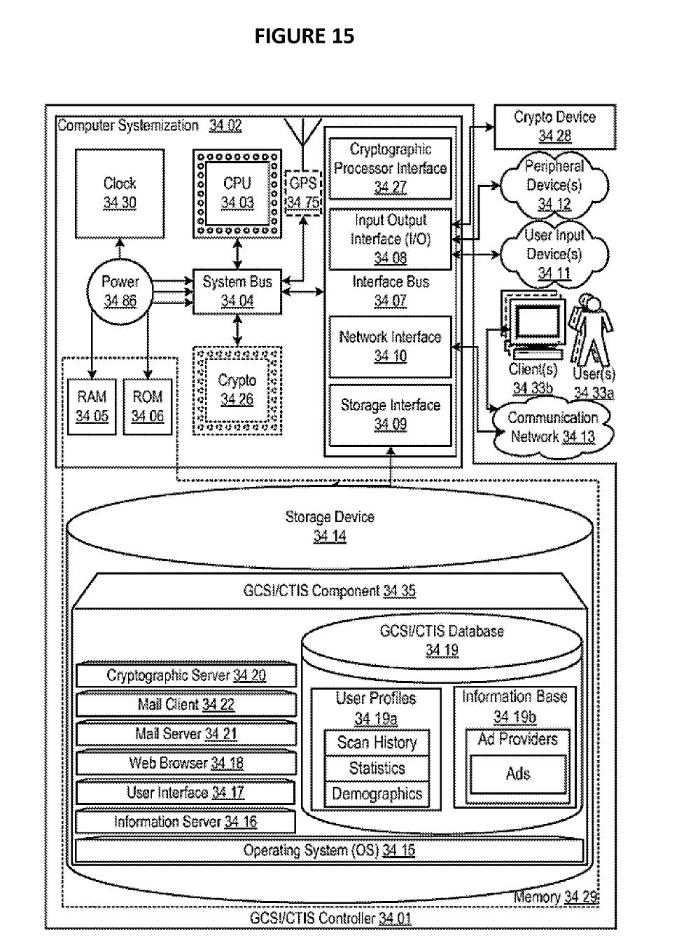

Generally shown in FIG. 15, in one embodiment, the code triggered information server controller 3401 may be connected to and/or communicate with entities such as, but not limited to: one or more users from user input devices 3411; peripheral devices 3412; a cryptographic processor device 3428; and/or a communications network 3413.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The code triggered information server controller 3401 may be based on common computer systems that may comprise, but are not limited to, components such as: a computer systemization 3402 connected to memory 3429.

### Computer Systemization

A computer systemization 3402 may comprise a clock 3430, central processing unit (CPU) 3403, a read only memory (ROM) 3406, a random access memory (RAM) 3405, and/or an interface bus 3407, and most frequently, although not necessarily, are all interconnected and/or communicating through a system bus 3404, as shown in FIG. 15. Optionally, the computer systemization may be connected to an internal power source 3486. Optionally, a cryptographic processor 3426 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the code triggered information server controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 3486 may be of any standard form for powering small electronic circuit board devices such as the following power cells: alkaline, lithium hydride, lithium ion, lithium polymer, nickel cadmium, solar cells, and/or the like, as shown in FIG. 15. Other types of AC or DC power sources may be used as well. In the case of solar cells, in one embodiment, the case provides an aperture through which the solar cell may capture photonic energy. The power cell 3486 is connected to at least one of the interconnected subsequent components of the code triggered information server thereby providing an electric current to all subsequent components. In one example, the power source 3486 is connected to the system bus component 3404. In an alternative embodiment, an outside power source 3486 is provided through a connection across the I/O 3408 interface. For example, a USB and/or IEEE 1394 connection carries both data and power across the connection and is therefore a suitable source of power.

### Interface Adapters

Interface bus(ses) 3407 may accept, connect, and/or communicate to a number of interface adapters, conventionally although not necessarily in the form of adapter cards, such as but not limited to: input output interfaces (I/O) 3408, storage interfaces 3409, network interfaces 3410, and/or the like, as shown in FIG. 15. Optionally, cryptographic processor interfaces 3427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3409 may accept, communicate, and/or connect to a number of storage devices such as, but not limited to: storage devices 3414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like, as shown in FIG. 15.

Network interfaces 3410 may accept, communicate, and/or connect to a communications network 3413. Through a communications network 3413, the code triggered information server controller is accessible through remote clients 3433b (e.g., computers with web browsers) by users 3433a, as shown in FIG. 15. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 3410 may be used to engage with various communications network types 3413. For example, multiple network interfaces may be employed to allow for the communication over broadcast, multicast, and/or unicast networks.

Input Output interfaces (I/O) 3408 may accept, communicate, and/or connect to user input devices 3411, peripheral devices 3412, cryptographic processor devices 3428, and/or the like, as shown in FIG. 15. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 3411 may be card readers, dongles, finger print readers, gloves, graphics tablets, joysticks, keyboards, mouse (mice), remote controls, retina readers, trackballs, trackpads, and/or the like.

Peripheral devices 3412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the code triggered information server controller may be embodied as an embedded, dedicated, and/or monitor-less (i.e., headless) device, wherein access would be provided over a network interface connection.

Cryptographic units such as, but not limited to, microcontrollers, processors 3426, interfaces 3427, and/or devices 3428 may be attached, and/or communicate with the code triggered information server controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information is regarded as memory 3429, as shown in FIG. 15. However, memory is a fungible technology and resource, thus, any number of memory embodiments may be employed in lieu of or in concert with one another. It is to be understood that the code triggered information server controller and/or a computer systemization may employ various forms of memory 3429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 3429 will include ROM 3406, RAM 3405, and a storage device 3414. A storage device 3414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

### Component Collection

The memory 3429 may contain a collection of program and/or database components and/or data such as, but not limited to: operating system component(s) 3415 (operating system); information server component(s) 3416 (information server); user interface component(s) 3417 (user interface); Web browser component(s) 3418 (Web browser); database(s) 3419; mail server component(s) 3421; mail client component(s) 3422; cryptographic server component(s) 3420 (cryptographic server); the code triggered information server component(s) 3435; and/or the like (i.e., collectively a component collection), as shown in FIG. 15. These components may be stored and accessed from the storage devices and/or from storage devices accessible through an interface bus. Although non-conventional program components such as those in the component collection, typically, are stored in a local storage device 3414, they may also be loaded and/or stored in memory such as: peripheral devices, RAM, remote storage facilities through a communications network, ROM, various forms of memory, and/or the like.

### Operating System

The operating system component 3415 is an executable program component facilitating the operation of the code triggered information server controller. Typically, the operating system facilitates access of I/O, network interfaces, peripheral devices, storage devices, and/or the like. The operating system may be a highly fault tolerant, scalable, and secure system such as Apple Macintosh OS X (Server), Apple iOS, AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP/7 (Server), Microsoft Mobile/Phone, Android, Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the code triggered information server controller to communicate with other entities through a communications network 3413. Various communication protocols may be used by the code triggered information server system controller as a subcarrier transport mechanism for interaction, such as, but not limited to: multicast, TCP/IP, UDP, unicast, and/or the like.

The operating system component 3015 may also be a mobile operating system, mobile OS, such as iOS (Apple), ANDROID, WINDOWS PHONE (Microsoft), WINDOWS PHONE 7 (Microsoft), BLACKBERRY OS (RIM), WebOS (Hewlett-Packard), MEEGO or SYMBIAN, for example. The mobile OS may be a manufacture-built proprietary operating system, a third party proprietary, or an open source operating system. Mobile OS' are employed on a wide variety of mobile devices useful with the present invention, such as smartphones and tablet computers.

### Information Server

An information server component 3416 is a stored program component that is executed by a CPU, as shown in FIG. 15. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the code triggered information server controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the code triggered information server database 3419, operating systems, other program components, user interfaces, Web browsers, and/or the like.

Access to the code triggered information server database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the code triggered information server. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the code triggered information server as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua or Lion, Microsoft's Windows XP, Microsoft Windows 7/8 or Unix's X-Windows provide a baseline and means of accessing and displaying information graphically to users. Mobile OS's, discussed above, also typically employ GUIs, but may also be text-based, and provide user interfaces to mobile devices.

A user interface component 3417, whether on a desktop or laptop computing device or a mobile device, is a stored program component that is executed by a CPU. The user interface may be a conventional graphic user interface as provided by, with, and/or atop operating systems and/or operating environments such as Apple Macintosh OS, e.g., Apple iOS, Android, Aqua or Lion, GNUSTEP, Microsoft Windows (NT/XP), Microsoft Windows 7/8, Windows Phone, Windows Mobile, Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3418 is a stored program component that is executed by a CPU, as shown in FIG. 15. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the code triggered information server enabled nodes. The combined application may be nugatory on systems employing standard Web browsers.

### Mail Server

A mail server component 3421 is a stored program component that is executed by a CPU 3403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the code triggered information server.

Access to the code triggered information server mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3422 is a stored program component that is executed by a CPU 3403, as shown in FIG. 15. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3420 is a stored program component that is executed by a CPU 3403, cryptographic processor 3426, cryptographic processor interface 3427, cryptographic processor device 3428, and/or the like, as shown in FIG. 15. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the code triggered information server may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the code triggered information server component to engage in secure transactions if so desired. The cryptographic component facilitates the secure accessing of resources on the code triggered information server and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Code Triggered Information Server Database

The code triggered information server database component 3419 may be embodied in a database and its stored data, as shown in FIG. 15. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the code triggered information server database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the code triggered information server database is implemented as a data-structure, the use of the code triggered information server database 3419 may be integrated into another component such as the code triggered information server component 3435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

Alternatively, the CTIS database 3019 may be decentralized and distributed across multiple server sites or reside entirely within a Cloud Computing Environment (the “Cloud”), as shown in FIG. 15. Further, the CTIS database 3019 may consist of multiple databases distributed across the Internet or in the Cloud, and may, for example, include various search commercial engines such as GOOGLE, YAHOO SEARCH, BING or the like as data look up resources and pointers to URLs of putative interest to a user.

In one embodiment, the database component 3419 includes several tables 3419a,b. A user profile table 3419a includes fields such as, but not limited to: a user ID, name, email address, address, demographic profile, health information, product preference, shopping history, hobbies, hardware ID, scan history record, scan statistics, and/or the like, as shown in FIG. 15 The user profile table may support and/or track multiple entity accounts on a code triggered information server. An Information Base table 3419b includes fields such as, but not limited to: Ad provider ID, Ad ID, Ad content, Ad labels, geographic tags, temporal tags, subject tags, Ad ratings, Ad statistics, and/or the like.

In one embodiment, the code triggered information server database may interact with other database systems. For example, employing a distributed database system, queries and data access by OLBS modules may treat the combination of the code triggered information server database, an integrated data security layer database as a single database entity.

In one embodiment, user programs may contain various user interface primitives, which may serve to update the code triggered information server. Also, various accounts may require custom database tables depending upon the environments and the types of clients the code triggered information server may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3419a,b. The code triggered information server may be configured to keep track of various settings, inputs, and parameters via database controllers.

The code triggered information server database may communicate to and/or with other components in a component collection, including itself, and/or facilities of the like. Most frequently, the code triggered information server database communicates with the code triggered information server component, other program components, and/or the like. The database may contain, retain, and provide information regarding other nodes and data.

### The Code Triggered Information Server

The code triggered information server component 3435 is a stored program component that is executed by a CPU, as shown in FIG. 15. The code triggered information server affects accessing, obtaining and the provision of information, services, transactions, and/or the like across various communications networks.

The code triggered information server component enables the identification, generation, and aggregation of Scan Messages and Reply Messages.

The code triggered information server component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the code triggered information server employs a cryptographic server to encrypt and decrypt communications. The code triggered information server component may communicate to and/or with other components in a component collection, including itself, and/or facilities of the like. Most frequently, the code triggered information server component communicates with the code triggered information server database, operating systems, other program components, and/or the like. The code triggered information server may contain, communicate, generate, obtain, and/or provide program component, system, user, and/or data communications, requests, and/or responses.

In a further embodiment, the code triggered information server may interact with one or more third-party database systems to retrieve requested information. For example, the CTIS may receive a request for information regarding a product. In turn, the CTIS accesses a third-party database containing the information requests, e.g., a database maintained by the manufacturer of the product, a database maintained by a retailer, or a database maintained by a product information aggregator (e.g., Google Shopping). The database accessed is also determined by the type of information requested. Types of information requested includes brand information, products by brand name, product images, URLs for branded products, point of purchase URLs, customer reviews of branded products, pricing, product information, product descriptions, product registrations, product compositions, product configurations, product interactions, styles, medical reference, drug information; drug interactions, drug compatibility, supplement compatibility, and drug recalls.

### Distributed Code Triggered Information Server

The structure and/or operation of any of the code triggered information server node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the code triggered information server controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

### Scan and Reply Messages for an Informed Response

In one embodiment, a code triggered information server (CTIS) employs two basic actors: (i) a user (100a) capable of registering interest in an activity, transmitting and receiving data, selecting a domain of interest for the information, and displaying information; and (ii) a server (101) capable of communicating with the user, storing/updating user profiles, and selecting information to serve to the user according to the domain of interest selected. In addition to the two basic actors, the CTIS enables the creation of two types of transactional articles: i) Scan Messages (115) and ii) Reply Messages (140). The CTIS provides context-specific or domain specific Reply Messages in response to Scan Messages, which are prepared in response to instructions received from the user, in order to supply product information to the user. The CTIS generates Reply Messages by processing Scan Message content with user profile information, containing basic profiling data as well as a history of Scan Messages supplied by a given user. As such, Reply Messages are transactional articles that heighten a provider's opportunity to supply relevant and targeted information and/or advertising to the user that is both context and user specific. In one embodiment, the user may select a particular domain of interest in which to receive the Reply Message from the CTIS and additional Scan Messages for data captured may be requested by the a digital device. The targeted information may be informed by and responsive to the instruction received from the user. Without loss of generality, the targeted information and/or content may be referred to as Reply Messages or as “Informed Responses.” The CTIS may also elect to send context and user-specific Reply Messages based solely on the user profile, without the user having recently registered activity interest, if it is determined from the user's profile, particularly the history of Scan Messages, that a particular Ad is appropriate.

The digital device itself may conduct the data processing of the data capture and give informed responses to the user (either by way of an installed application or inherent in the operating system of the digital device). The CTIS provides/stores the user profile and send reply messages for the informed responses, the digital data capture device do inherently provide these capabilities by appropriate coding or software implementation. The digital device may therefore store data and retrieve the stored data for a related query. Also the digital device may augment previous results stored on the device with additional information retrieved for associated databases, internet search, 3rd party databases, and the like. The digital device would submit a structured query to the CTIS, database, etc. for new queries.

### Artifact Capture

In one embodiment, users of the CTIS scan artifacts to indicate interest in a particular product and the CTIS acts as a portal for consumers to access information supplemental to the context in which the codes are found. Users may scan artifacts using a digital capture device, such as a smartphone, a tablet computer, notebook computer, digital camera, or other similar devices. Artifacts can be found in media publications, on billboards or signs, on consumer products or packages, on websites or television screens, and/or the like. In doing so, the users may identify themselves via an identification code specific to the digital capture device and service account with which the scan is made. At the same time, the scanned artifact can be recorded, as well as the time of day and user location; such information may form the basis of consumer profiles that may be saved by the CTIS. The consumer profile can be expanded to include further information about the user, including hobbies, product preferences, demographic information, health information, and the like. As these scans are indicative of interest in various subjects, goods, and/or services, they may serve as a basis for an individual customer tracking system.

The data captured may be single mode or multi-modal data, and may consist, for example of any sensory-type input, e.g., visual, auditory, olfactory, haptics or gustatory. Visual inputs may consist of image capture, pattern recognition, text recognition, bar codes, such as UPC or QR codes, hand gestures, or the like. Auditory inputs may consist of music, sound recognition, sound pattern recognition, spoken word recognition, or the like. Olfactory inputs may consist of inputs from artificial noses, such as that described by Stitzel, S. E., et al. in Artificial Noses, Ann. Rev. Biomed. Eng. Vol. 13, 1-25 (August 2011) or in U.S. Pat. No. 7,261,857, gas chromatographs or other instruments for detecting the presence of airborne elements. Tactile inputs may consist of data acquired by virtue of surface roughness measurements, such as by atomic force microscopy, by a tactile-sensing system such as that described by Decherchi, S., et al., IEEE Transactions on Robotics, 27(3), 635-639, June, 2011, or by tactile sensors as described in U.S. Pat. No. 7,823,467, each of which is expressly incorporated by reference. Finally, gustatory, or the taste inputs, may be obtained by employing a taste sensor, such as that described in U.S. Pat. No. 7,858,036 or the taste sensor data system described in U.S. Patent Application Publication No. 20040107053, each of which is expressly incorporated by reference.

Thus, the data capture device 100b may be any device suitable for capturing sensory data from an artifact in which the user has interest and communicating captured sensory data to a computing device or server. In one embodiment, the data capture device 100b may be in the proximity contact with the product of interest, such as Near Field Communications (NFC), Radio Frequency Identification (RFID), Bluetooth, Infrared, Wireless communication, and other short range communications and the like.

As discussed above, artifacts capable of being capture include, among other things, 3D barcodes that are have regions of differing heights, with the regions, their patterns and their relative heights being representative of data. In accordance with one embodiment of the present invention, the three dimensional nature of artifacts, including barcodes, may be used advantageously for allowing sight or hearing impaired individuals to capture data from artifacts with 3D codes, whether 3D barcodes per se, or other 3D surfaces capable of acting as data sources, and have that data captured, processed and provided to such individuals in a form that makes the information encoded by the 3D data more available to the user. In one particular embodiment, sight impaired individuals often employ their haptic senses to, for example, read using braille, to scan products to identify container shapes or features or the like. These skills are, of course, learned and require considerable effort on the part of the individual. The present invention may be used with sight impaired individuals to capture sensory data otherwise unavailable or difficult to access to such individuals and convert the sensory data into a usable form, e.g., sounds. Similarly, in accordance with another embodiment of the invention, a hearing impaired individual may use the present invention to capture audible sensory data, e.g., music, street sounds, warning sounds or the like, and covert such unavailable or difficult to access sensory data in a form, e.g., visual, that renders such audible sensory data more available and meaningful to a hearing impaired individual. In this manner, the present invention may be employed to simply capture and convert data existent in one sensory form to another sensory form that is more useful or available to a user having a particular disability or impairment.

### Code Triggered Information Server Basic Overview

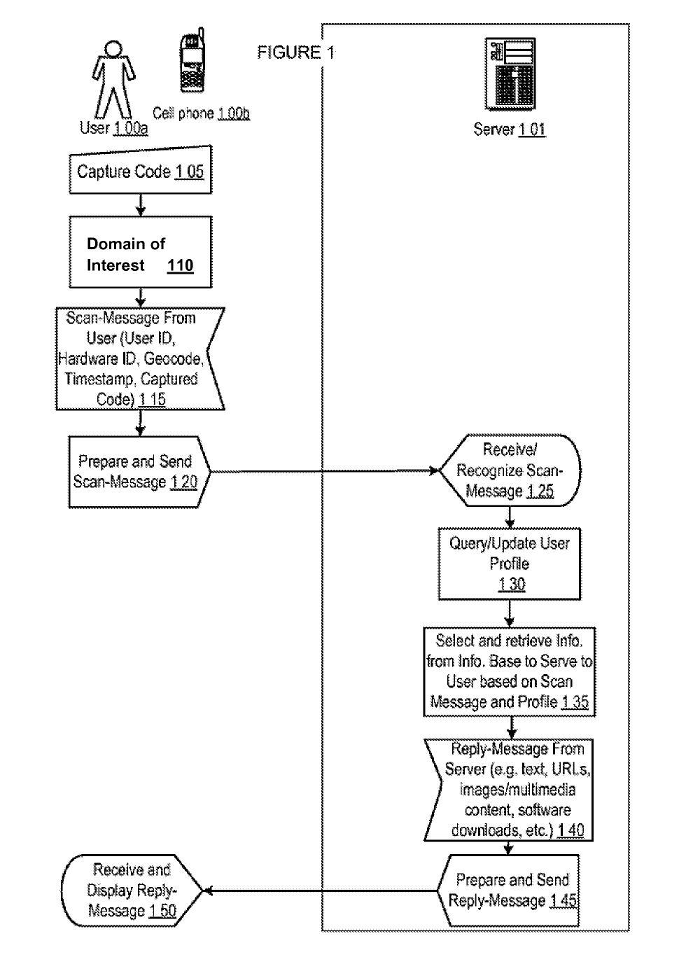

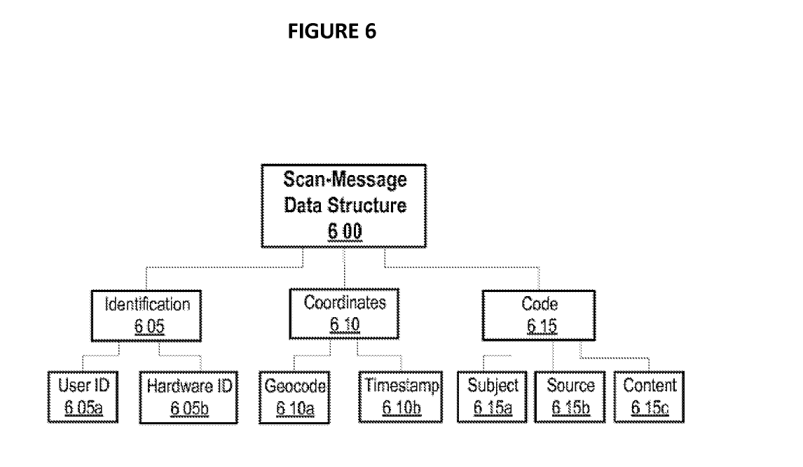

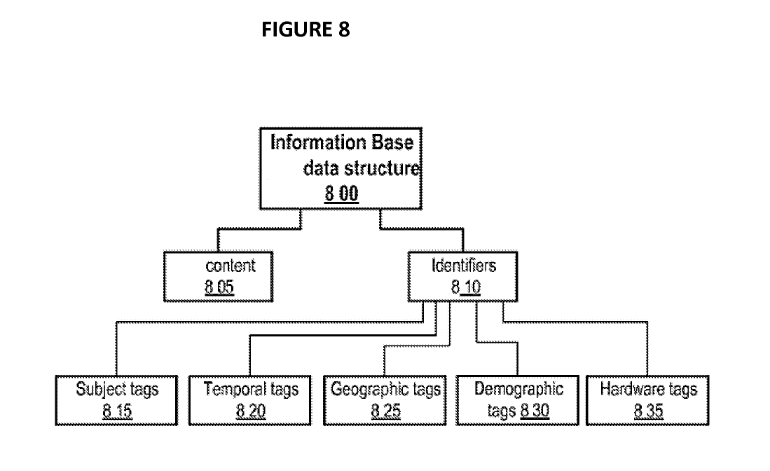

FIG. 1 shows a combined logic and data flow block diagram illustrating a general overview of the CTIS in one embodiment. The CTIS may be configured so that a user (100a) may scan an artifact (105) with a scanning device (100b), as for example by using a cell phone camera to scan and/or take a picture of a barcode, 2d code, matrix code, data matrix, QR code, NFC, or other such scanning or symbology. Other artifacts include without limitation brand logos, product packaging, and identifying text such as serial numbers, vehicle identification numbers, etc. An example of a mobile device and software capable of such artifact capture is the Nokia 6600 cellular telephone equipped with ConnexTo software. Alternatively, the CTIS may be triggered by the user selecting an internet link (such as on an internet enabled mobile device), by making decisions within a virtual world (such as a massively multiplayer online game), and/or the like. Without loss of generality, all such forms of interest-registering CTIS triggering will be referred to as “artifact scanning”. In one embodiment, the time and location (as determined by GPS, GPRS, or other such geo-positioning technologies) of the mobile device may be determined and the user selects an appropriate domain of interest (110) to receive the Informed Response, and a Scan Message (115) is generated containing a user identification (ID), a hardware ID that identifies the type of mobile device being used, a domain of interest, and optionally a geocode (location of the device), a timestamp, and the scanned code (see FIG. 6 and discussion of Scan Message below). Additional user-input information may also be supplied at this point. Furthermore, the user may provide an instruction for a server (101) that dictates the type of information the user desires in response. The scanning device 100b may bring up a series of options from which the user can select based on a query or domain of interest 110 to request additional scanning or image/data capture. The additional data capture artifacts and the domain of interest 110 that is selected by the user is sent along to the CTIS. The Scan Message along with the domain of interest is packaged and sent (120) to the server that receives and recognizes it (125). The user's profile, specific to the supplied user ID, is updated with the new Scan Message (i.e., it is added as a transaction to their profile transaction history) and queried (130) for information to use in the preparation of a Reply Message (140) that is also based on the content of the current Scan Message and domain of interest selected by the user. The server selects (135) the Informed Response (see FIG. 8) for the Reply Message from an Information Base and sends it to the user's mobile display device (145), which displays the pertinent content to the user (150). The content of the Information Base depends upon the nature of the artifact scanned, as well as previous input by the user.

### MMS

In one implementation, the Scan Message and/or scanned code may be sent to the server (101) by a Multimedia Messaging Service (MMS) protocol. In other implementations, a wide variety of other communication protocols may be employed, including but not limited to: Short Messaging Service (SMS), instant messaging, web browser based messaging, email, Enhanced Messaging System (EMS), TCP/IP, WAP, and/or the like.

### Short Code

In one implementation, the server (101) may be addressed by a short code, short numbers, Common Short Code (CSC), and/or the like for sending the Scan Message and/or scanned code. For example, a short code may appear alongside a code in a print publication, and a user may be informed that the scanned code should be sent to the indicated short code number in order to retrieve a Reply Message, advertisement, coupon, and/or the like. In other implementations, other addressing means may be employed, such as an ordinary telephone number, an email address, a universal resource locater (URL), and/or the like. In another implementation, the short code and/or other server address may be encoded within part of the code itself. When the user scans the code with his or her mobile device, the code may be partially decoded by the client device to extract the address and automatically send the rest of the code thereto.

### Artifact Scanning

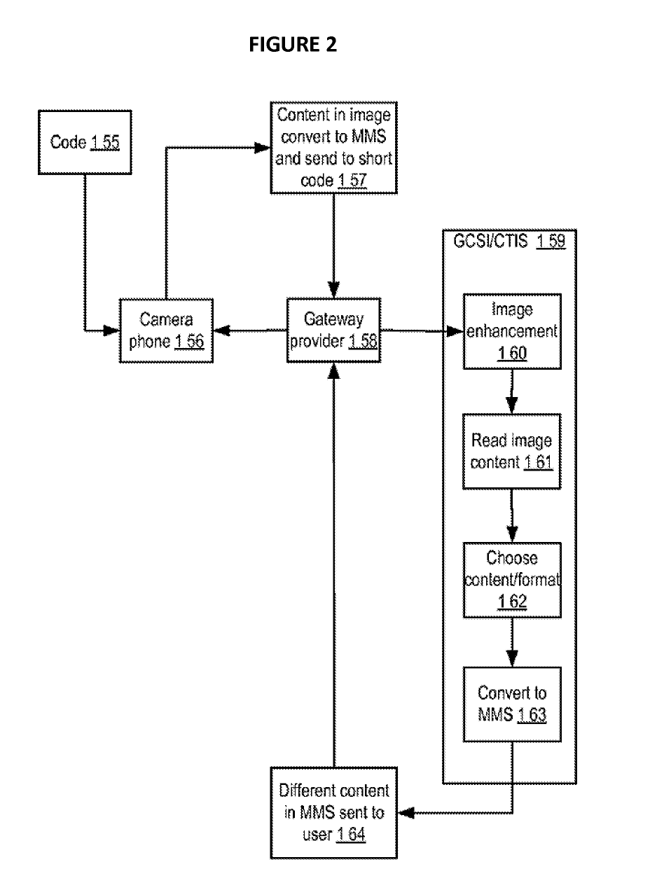

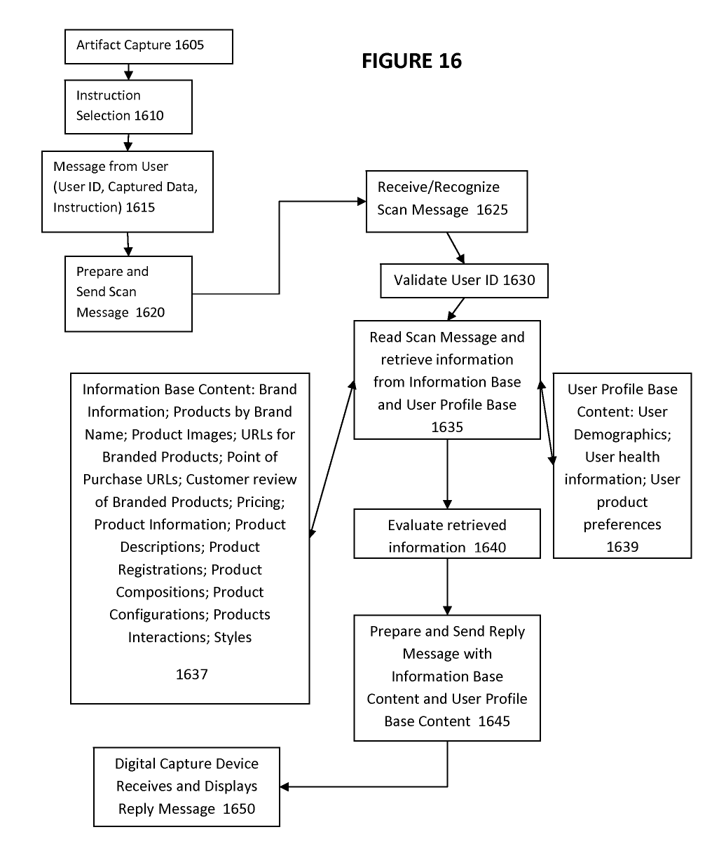

FIG. 2 shows an implementation of combined logic and data flow in another embodiment of CTIS operation. A code (155) is scanned by a camera phone (156), and the resulting image content is converted to an MMS format to be sent via short code (157) through a gateway provider (158) to the CTIS (159) server. At the server, the image information may be enhanced, manipulated, and/or otherwise processed (160) so as to aid in determining the appropriate content to serve in response. After enhancement, the image content is read (161) and the content and format for the Informed Response is determined (162) (see, e.g., FIGS. 16-18). A response message is formed in MMS format (163) and is sent (164) back to a gateway provider (158) to be served to the user's camera phone (156).

In an alternative implementation, the scanned code may be directly decoded on the client mobile device instead of on the server. The decoded content may then be converted to MMS format and sent via short code to the server in order to retrieve the appropriate content associated with the code. That content may be returned from the server to the client mobile device by means of an MMS protocol as well.

### CTIS Server

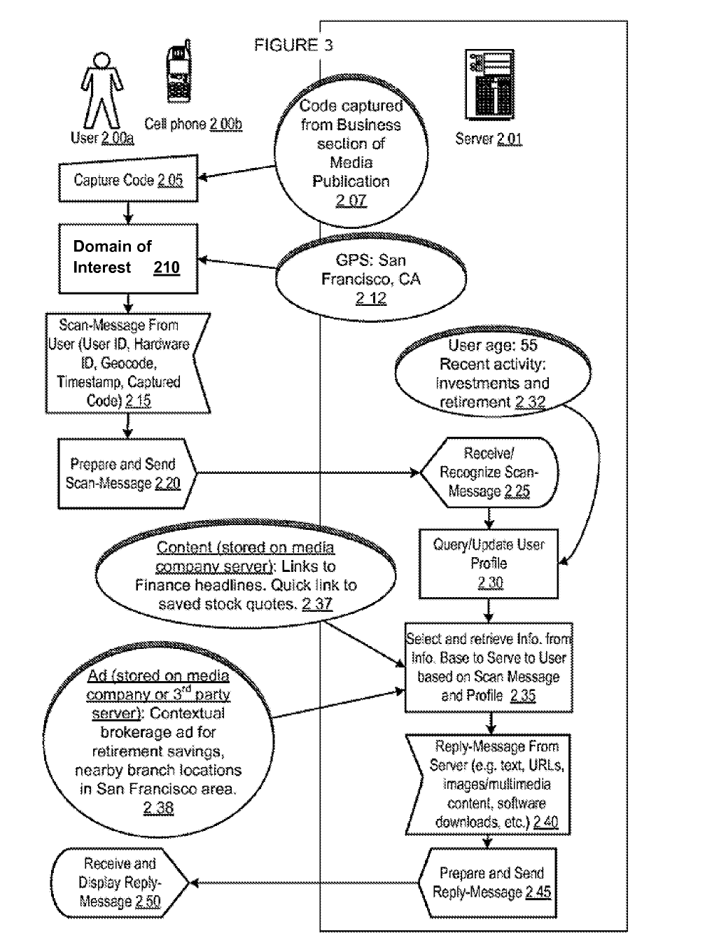

For illustration, the CTIS is shown in FIG. 3 for a particular, exemplary embodiment: providing targeted and contextual information and advertising to the user related to a news article. Here, a user employs a cell phone to scan a code associated with an article in the Business section of a media publication (207), such as by using the phone's built in camera to photograph a 2D matrix code (e.g., QR code). The location of the scan (San Francisco, Calif.) is determined by the phone's built in GPS receiver (212), and this location is incorporated as a geocode, along with the user ID, the hardware ID of the particular type of device (e.g., cell phone) used, the time, along with a domain of interest selected by the user, and the code content, into a Scan Message 215. This is sent to a server via the cell phone's data connection (e.g., wireless internet systems such as 1xEV-DO), and the server queries a database of user profiles based on the supplied user ID in order to update the appropriate user profile with the content of the current Scan Message and to determine what, if any, information in the user profile may be relevant to the preparation of the current Reply Message and domain of interest selected. Here, the server recognizes that the user is 55 years of age and has recently been scanning articles and/or ads related to investments and retirement planning (232). In one embodiment, the user can supply a list of interests to be considered in addition to those culled from their scan history and optionally can select a domain of interest in which to receive the Informed Response. The server selects the appropriate Informed Response to include in the Reply Message considering the domain of interest, comprised in this case of links to Finance headlines, quick links to saved stock quotes (237), and a contextual brokerage advertisement (238), including information on branch locations in San Francisco (212) near the user. This reply is sent by the server to the user's mobile device which displays the appropriate message content.

If the product information is coming from a third party server, associated databases, product databases, internet search or database for the informed response, the CTIS may generally communicate and interface with the third party server, associated databases, product databases, internet search or database. The CTIS may interface with a third party server or database in any communication preference, one of which is through a Communication Network. Other interfaces contemplated included directly associated databases that may be offered as part of an overall service, internet search (e.g. Google, Yahoo, Bing, Alibaba, etc.), and third party databases aligned with a CTIS (as a “for fee” service from the 3rd party database vendor), etc.

Image Capture of Product/Product Packaging

### User and Product or Service Provider Participation

The informed response may be non-ad bearing as well as associated ads if found as part of a search or otherwise derived during the search process. Coupons may also be sent or revealed to the user as a part of the over all response). In one embodiment, if the user is looking for information relating to the used car and in developing the informed response the search/query algorithm comes across a dealer in the user's area/location (may or may not be from the dealer the user happens to be evaluating the cars from) who is offering a special dealer only discount of promotion, the user may be alerted with an informed response from the competing dealer and the discount, promotion, or coupon.

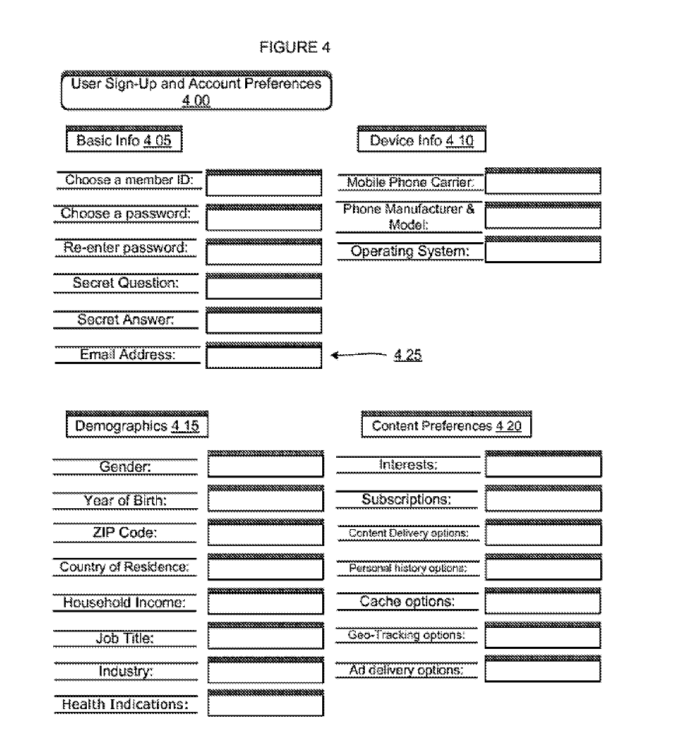

The CTIS may be enabled by the participation of product or service providers and users. In one embodiment, product or service providers supply information for storage on the CTIS server. The product or service providers may be for any type of information, consumer, medical, technology, government, etc., that provides a service or product. In an alternative embodiment, the product or service provider information is stored on third party servers that are referenced by the CTIS server. The user experience may be enhanced by the incorporation of personal preferences and demographic information to optimize the targeting of Informed Responses. Consequently, one embodiment would incorporate a user registration procedure. Users may register for the CTIS via the internet, telephone, postal mail, and/or the like. If a particular embodiment of the CTIS requires client software for the user to install, this could be supplied upon successful user registration. FIG. 4 shows an exemplary embodiment of a user registration interface 400, wherein a user can input Basic Info 405 (e.g., member ID, password, secret question/answer, e-mail address, etc.), Device Info 410 (e.g., mobile phone carrier, phone manufacturer & model, operating system, etc.), Demographics 415 (e.g., gender, year of birth, zip code, country of residence, household income, job title, industry, etc.), and Content Preferences 420 (e.g., interests, subscriptions, content delivery options, personal history options, cache options, geo-tracking options, ad delivery options, etc.) in a plurality of fields 425. In an alternative embodiment, a basic user identification packet (e.g., a “cookie”) is sent with a user's first code scan, thus establishing a basic user profile that can be filled in with greater detail at a later time.

Service providers, ad agencies, etc. can promote their goods and services thru listing in the CTIS database for a fee. The fee may be charged by click-through rates on the Informed Response displaying the website of the service provider, the number of informed responses sent providing the service provider information, and the like.

### Artifact Capture (105)

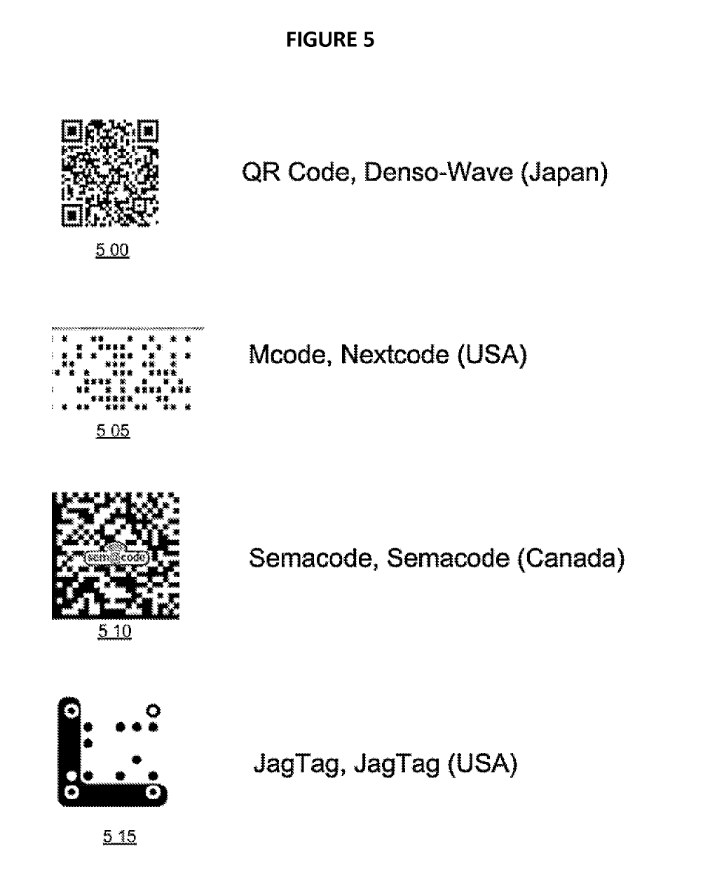

Scannable codes may be found in a variety of locations, including but not limited to newspaper and magazine articles, signs and billboards, flyers, store locations and kiosks, consumer products, packages, clothing, stickers, websites, software displays, television broadcasts, virtual worlds, geographic landmarks, e.g., buildings, topographical features, such as mountains or coastlines, and/or the like. The nature of the code and associated method with which the code can be scanned will depend to some extent on where the code is found, but among the possible types of codes are standard barcodes (e.g., UPC, EAN, Code 128, etc.), 2D matrix codes (e.g., QR code, Semacode, Data Glyphs, mCodes, etc.), user-input codes (e.g., text messages), RFID tags, NFC tags, pure images (e.g., an image of a sign to be analyzed by optical character recognition), website links, software inputs, and/or the like. These codes may be located on any medium (e.g., on newspapers, magazines, books, video content, computer screens, embedded in objects (e.g., RFID tags on clothes, etc.), and/or the like). One embodiment employs 2D matrix codes, examples of which are provided in FIG. 5, due to their large data capacity, ease of scanning, and resilience to damage or error. These examples include QR codes 500, Mcodes 505, Semacodes 510, and/or the like. FIG. 5 also displays a fourth matrix code called a JagTag 515. The JagTag includes an aesthetically pleasing appearance and provides functionality that is more robust than other matrix codes.

### Domain of Interest (110)

The domain of interest 110 may be any appropriate domain in which the user wants to select to accompany the Scan Message as to receive the Informed Response. The domain of interest may be dependent upon the particular capture code or data captured from the data capture device. For example, if the data capture code is for a particular food product, the domain of interest may be food allergy, recipe selection, coupon options, comparative analysis, drug interactions, sports, hobbies, education, shopping, personal health, entertainment, business, personal finance, taxes, environment, restaurants, news, vacation, travel, romance, dating, photography, cameras, technology, mobile phones, TV's, GPS, home and car audio, laptops, tablets, computers, jewelry, watches baby, bath and beauty, clothes, insurance, credit cards, loans, gifts, holidays, pets, drinks and beverages, TV shows, movies, video games, books, concerts, celebrity brands, special needs, medical equipment, medicine, home remedies, parenting advice, and the like. Alternatively, if the data captured is several different products, the domain of interest may be a comparative analysis of the several different products as to price, features, specifications, and the like.

Generally, the domain of interest 110 may be any domain the user selects or the service provider provides, or the CTIS provides. The domain of interest may fit a user's special needs, such as a domain of interest for impairment (blind, hearing, etc.). As such, the domain of interest is readily modifiable, interchangeable with any domain that may be required. If the user does not find a domain that fits their need, the can structure a query wherein the user creates a specified domain in which case the CTIS performs an “ad-hoc” query and returns responses accordingly.

### Scan Message Data Structure (115)

The Scan Message generated by the CTIS is, itself, a novel data structure. In one embodiment that is illustrated in FIG. 6, it contains an identification field (605) comprising a unique user ID (605a) and a hardware ID (605b), both automatically supplied by the device used to scan and transmit the scanned code; a coordinate field (610) comprising the location geocode (610a) (e.g., GPS coordinate, latitude and longitude, city and state, etc.) and timestamp (610b) of the scan; and a code field (615) supplying the specific content of the scanned code, which may include a subject code (615a) for the code context, a source code (615b) indicating where the code was located, and a content code (615c) indicating the specific information, if any, to be supplied in response to a scan of that code.

In one embodiment, the XML for the Scan Message takes the following form:

<Scan_Message>
<ID>
<User ID> 012345 </User ID>
<Hardware ID> Nokia 660 </Hardware ID>
</ID>
<Coordinates>
<Geocode> GPS 40 46.516 −73 57.98 </Geocode>
<Timestamp> 08/21/2006 13:45:28 </Timestamp>
</Coordinates>
<Code>
<Subject> entertainment; movies; comedy </Subject>
<Source> New York Times </Source>
<Content> Showtimes for latest popular comedy movie </Content>
</Code>
</Scan_Message>

### Data Transmission (120, 125, 145, 150)

In one embodiment, sending and receiving the Scan Message and Reply Message will employ standard data transmission techniques to ensure successful transmission and to preserve data integrity (e.g., TCP/IP, 1xEV-DO, etc.). This is relevant for the Scan Message, which will contain the coded information scanned by the user. Such techniques may include but are not limited to the use of standard transmission protocols, “handshaking”, data compression, data encryption, and error correction.

### User Profile Structure (130)

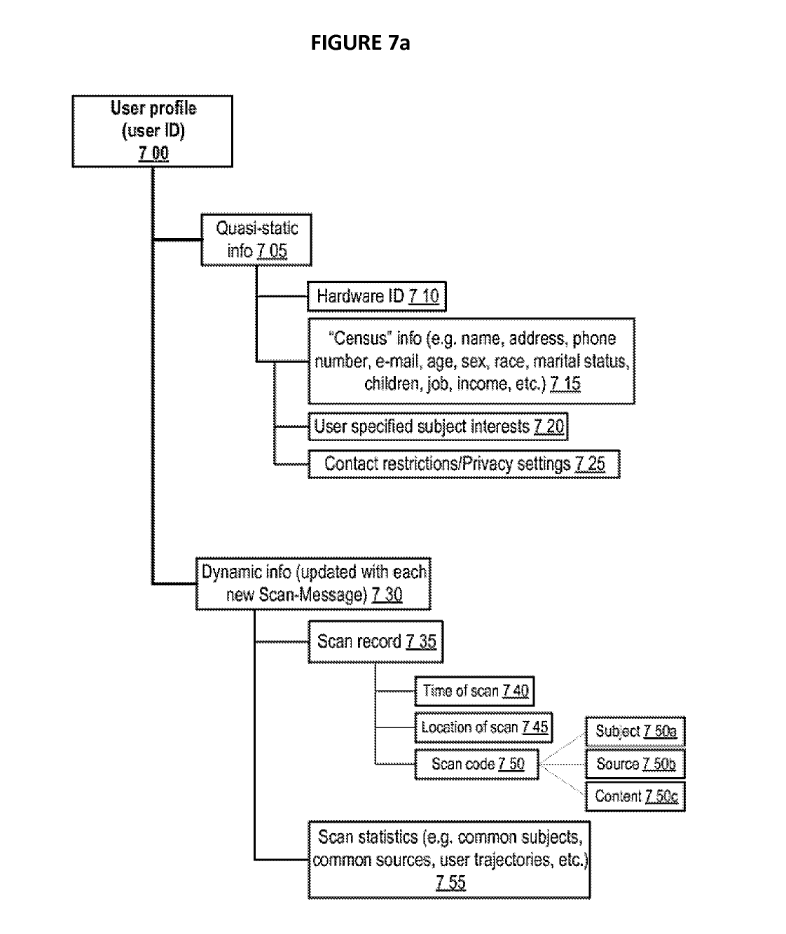

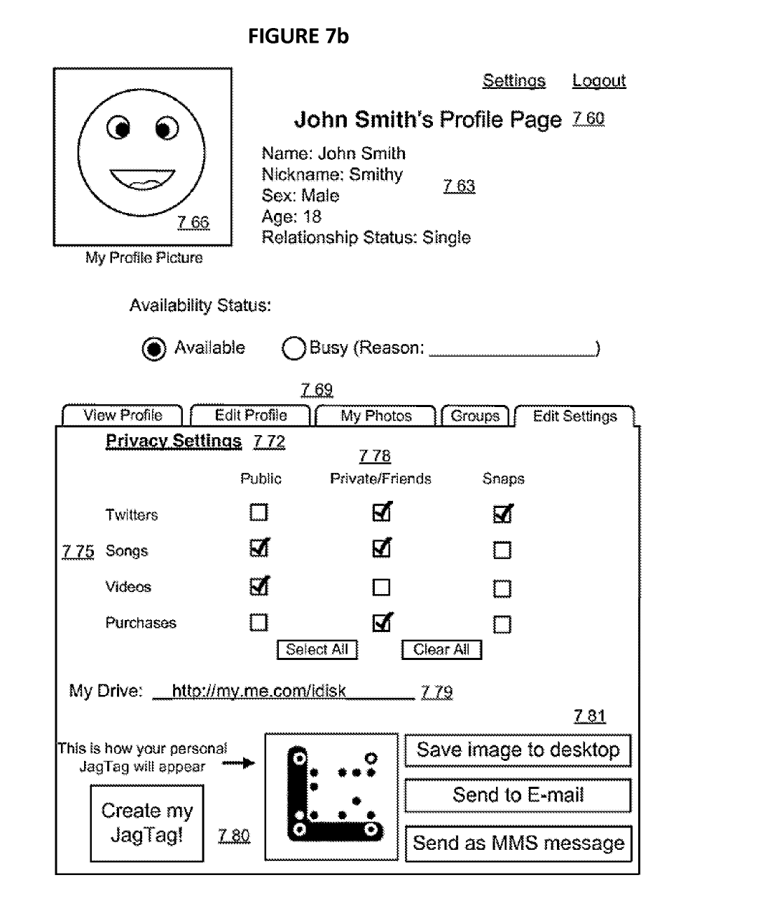

The content of the user profile generated by the CTIS is itself a novel data structure. In one embodiment illustrated in FIG. 7a, the profile (700), which is uniquely specified by the user ID, will contain a category of quasi-static user information (705) that is generally fixed over time and one of dynamic user information (730) that is updated with each successive Scan Message that the user submits. The quasi-static info (the “quasi” qualifier indicates that this information may be updated, for example if a user changes their mobile device, however it does not change with each successive code scan) may include a hardware ID (710); “census” info (715) such as name, address, phone number, e-mail address, age, sex, race, marital status, number and age of children, job title, annual income, etc.; subjects of interest specified by the user (720); and information regarding allowed methods to contact the user (725). The subjects of interests may be specified by the user on the data capture device as to pre-configure the data capture device. In one embodiment, this information could be supplied by the user when registering for the CTIS service as, for example, on a website. The dynamic info in the profile may include a scan record (735), comprising the time (740), location (745), and scan code (750) (including subject (750a), source (750b) and content (750c)); domain of interest preference, and statistics related to the scan history (755). Such statistics may include but are not limited to the most popular scan subjects, most popular scan sources, user space-time trajectories, domain of interest selections, etc. In one embodiment, the profile contains a series of identifying codes distilled from the profile content (e.g., demographic category code based on census info, subject codes, source codes, etc.) that can be compared with similar codes in the Scan Message to determine the appropriate Informed Response content to include in the Reply Message. In an alternative embodiment, the profile contains identifying keywords or “tags” based on the profile content that can be compared with similar tags in the Scan Message to determine the appropriate content to include in the Reply Message. In both cases, the identifying labels for the user profiles may be input by CTIS administrators or automatically generated by an appropriate computer algorithm such as stripping header labels from ad descriptions (e.g., for example, stripping the header tags from an HTML ad).

In one embodiment, the XML for the User Profile may take the following form:

<User>
<Quasi-static info>
<User_ID>123-45-6789</User_ID>
<Hardware ID> Nokia 660 </Hardware ID>
<Census info> John Smith; 123 Maple Dr., Smalltown, CA 92676;
(123)456-7890; jsmith@email.com; 55 years; male; white; married;
2 children; etc.
</Census info>
<Interests> camping; fishing; classic cars; movies; etc. </Interests>
<Contact restrictions> Weekdays 8 AM - 7 PM only </Contact
restrictions>
</Quasi-static info>
<Dynamic info>
<Scan record>
<Scan_#1>
<Time> 08/21/2006 13:45:28 </Time>
<Geocode> GPS 40 46.516 −73 57.98 </Geocode>
<Code>
<Subject> entertainment; movies; comedy </Subject>
<Source> New York Times </Source>
<Content> Showtimes for latest popular comedy movie </Content>
</Code>
</Scan_#1>
<Scan_#2>
etc...
</Scan_#2>
etc...
</Scan record>
<Scan statistics>
<Popular subjects> entertainment; cars; travel; etc. </Popular subjects>
<Popular sources> New York Times; Car and Driver; CNN.com;
etc. <Popular sources>
<Trajectories>Data files listing time and geocode coordinates, computed
average trajectories, likely locations, etc. </Trajectories>
etc...
</Scan statistics>
</Dynamic info>
<Code>
<Subject> entertainment; movies; comedy </Subject>
<Source> New York Times </Source>
<Content> Showtimes for latest popular comedy movie </Content>
</Code>
</User>

In one embodiment, data accumulated in a plurality of user profiles may be analyzed to extract information about codes that are scanned. For example, the frequency with which a particular code is scanned may be extracted from user profiles and parsed by geographic, temporal, and/or demographic criteria to yield code profiling information. This information may be stored in a code and/or Informed Response profile. In an alternative embodiment, the code/Informed Response profile may be constructed and/or updated by the CTIS immediately upon the receipt of a Scan Message rather than being extracted from user profiles.

Alternatively, the content of the user profile 700 may be generated and stored on the digital scanning device and/or also sent to the CTIS. For example, the user may pre-configure the digital scanning device 100b to include a number of preferred points. In one embodiment, the preferred points may be the user's allergies, which the user pre-configures the digital scanning device.

### Information Base (135)

### Informed Response and Labels—Searching

The Information Base contains the content that may be included in the Reply Message sent to the user for the Informed Response and may be stored on the CTIS central server or on third party servers accessed by the CTIS. In one embodiment, each domain of interest is associated with searchable labels. The Informed Response content together with its labels, collectively referred to here as an Informed Response, forms a novel data structure. In one embodiment illustrated in FIG. 8, the Informed Response (800) is comprised of the specific content (805) (e.g., text, images, video, etc.) and a set of identifiers (810) including subject tags (815), information characterizing the temporal character of the Informed Response based on which the Informed Response may be triggered (820) (e.g., 6 to 10 AM for when a particular product may be ingested in view of prescription drugs), information characterizing the geographic specificity of the Informed Response based on which the Informed Response may be triggered (825) (comparative analysis of product reveals additional products in other geographies), demographic specificity of the Informed Response (830) (e.g., an Informed Response for woman's cosmetic products), and the hardware requirements of the Informed Response (835) (e.g., hardware IDs of devices capable of displaying the content of a particular Informed Response). In one embodiment, the Informed Response would also contain information identifying the source in which the Informed Response code is to appear. In another embodiment, the Informed Response would also contain code/Informed Response profile data, describing the history and/or statistics of scans related to the Informed Response.

In one embodiment, the XML for an Informed Response may be in the following form:

<Informed Response >
<Informed Response _ID>123</ Informed Response_ID>
<Informed Response content>
textual movie showtime listings (or images, audio, video, URLs, etc.)
</ Informed Response content>
<Identifiers>
<Subject> entertainment; movies; comedy </Subject>
<Temporal> 08/21/2006; 12:00:00 to 14:00:00 </Temporal>
<Geographic> Smalltown, CA 92676 </Geographic>
<Demographic> 17 years and older </Demographic>
<Hardware> any (text only) </Hardware>
</Identifiers>
</Ad>
User Profile Query (130)

### Querying and Serving Information on the Internet

In an embodiment, the CITS delivers information on the internet based on user activities, such as may be registered by codes scanned by mobile devices or website links selected on a computer, as well as user characteristics and an accumulated history of user activities. For example, information and/or product or service providers may use CTIS to serve context, demographic, and behavior targeted information to users on the internet. In particular, information and/or Informed Responses are served on the internet that is targeted to the individual based on the individual's characteristic profile, behavioral patterns, and present contextual surroundings, either in real space of cyberspace. For example, a web-based Informed Response may be provided on an internet enabled mobile device for goods and services located near a mobile user, which Informed Response is selected based on the user's behavioral patterns and stated interests.

In one embodiment, the CTIS allows product and service providers to supply product information on websites to the consumers who would be most interested in particular Informed Responses; this may be achieved by the CTIS selecting content based on a combination of the context of the code that the consumer scanned or the web link that the user selected, the consumer's selection of the domain of interest, the consumer's stated interests as recorded in his or her user profile, the consumer's demographic profile, situational information, and a record of scanned codes or web links; these factors can be analyzed and employed by the CTIS for both user tracking and behavioral profiling/targeting. For example, a user with a stated interest in running and a recent pattern of scanning codes related to shoes may be served a web-based Informed Response on his/her internet-enabled mobile device for a new running shoe being sold at a nearby shoe store. In another example, a user profiled to be a teenager and having a pattern of browsing websites related to comic books may be served a web-based ad for the newest comic book themed movie when he/she visits a movie-listings website

Users, in turn, trigger the provision of information by scanning or observing codes or information, or by selecting web links. The triggers, together with geographic, temporal, and user-specific information, are obtained by the server that receives, processes, and records the message. Based on these messages and a user profile—which may include continuously updated user-specific behavior information, situational and ambient information, an accumulated history of trigger messages, and integration with outside database information—the server selects information to serve to a user on the internet from an information base.

For example, a user with a recorded history of interest in coffee products may be served an Informed Response for a nearby coffee shop while browsing the web on his/her PDA. In one embodiment, information may also be served to users on the internet based solely on the user profiles, and without any initiating trigger. This is based on user trajectories or web-surfing habits deduced from the accumulated history of triggers. For example, a user known to routinely visit a music vendor website near the same time each day may be served an Informed Response for the latest top-selling CD shortly before that time.

In another embodiment, the user initiates the provision of information by first selecting a web link on a web page or by selecting a menu option in a computer program, such as an application for a smartphone or tablet computer. The user then scans or observes codes or information that is sent to the server that receives, processes, and records the content of the user's message. Depending upon the previous web link or menu option selection made by the user, the server provides information consistent with that selection.

### Information Querying and Serving on Mobile Devices Based on Profiles

In an embodiment, information querying and serving are triggered by codes that are scanned by a user. The information is selected based on the profile of the user. In an illustrative example, a user who is profiled as a teenager with a stated interest in comic books and a record of scanning codes related to movies may be served an Informed Response for the latest comic book themed movie playing in the next hour near his/her present geographic position the next time he/she scans a code from the entertainment section of the newspaper.

### Code-Mediated Content Delivery Platform

Embodiments are directed to apparatuses, methods, and systems for a code-mediated content delivery platform comprising a Graphical Code-Serving Interface and a Code Triggered Information Server (“GCSI/CTIS”). The GCSI/CTIS connects information encoding symbologies, and by proxy the underlying information content, to graphical display elements and/or to graphical interface elements and facilitates generation of encoding symbologies, error-correction, media sampling and purchasing, social networking, and sales promotion programs.

In an embodiment, active display elements provide access to information, particularly information that is targeted to an individual's profile, interests, and/or contextual surroundings and that is portable and/or made available in unexpected physical locations. The active display elements facilitate the serving of such information via placement of information encoding symbologies, such as matrix codes, proximate to graphical elements in a wide variety of digital display contexts and media, including portable display devices, mp3 players, cell phones, digital paper, animated billboards, websites, internet or television broadcasts, software interfaces, and/or the like. Users may capture images of information encoding symbologies from such displays, for example using a cell phone camera, and decode them with software applets to receive additional information, multimedia content, offers, coupons, notifications, and/or the like.

In one embodiment, a code sent via a communications network from a mobile communications device from a user is received. The code is based on a scan of an optically-readable coding symbol. A code database is queried to discern a multimedia content data identifier corresponding to the received code. Multimedia content data is retrieved from a multimedia database based on the multimedia content data identifier. A sample of the multimedia content data is sent to the mobile communications device via a communications network. A sample acceptability message is received from the user. The multimedia content data is sent to a data repository associated with the user provided that the sample acceptability message indicates that the user wishes to receive the multimedia content data.

In another embodiment, an alphanumeric string comprising a plurality of characters and representing a location of multimedia content data is received from a first data source. Each of the plurality of characters of the alphanumeric string is converted into a corresponding binary number to yield a plurality of binary numbers based on a character correspondence table. The plurality of binary numbers is concatenated to yield a bitwise array. An optically-readable encoding symbol comprising a plurality of disconnected solid shapes is drawn in which the presence of a solid shape at a position in the symbol indicates presence of a 1 in a corresponding position of the bitwise array.

Users may scan codes found in media publications, on billboards or signs, on consumer products or packages, on websites or television screens, on movie screens, on clothing or accessories, on mobile device displays, and/or the like.

In an alternative implementation, content associated with a captured code or other user interest registration may be sent to a data repository other than a user's mobile device. For example, a user may scan a code corresponding to media content. Rather than triggering the GCSI/CTIS to send the media content to the mobile device with which the code was scanned, the code scan may trigger the GCSI/CTIS to send the media content to a user's computer, an online data repository, and/or the like for storage and later retrieval by the user. For example, the GCSI/CTIS may discern a user identity from the Scan Message (115), query user access and/or authorization information, and use that access and/or authorization information to access an online data repository corresponding to the user to store requested media content thereon for later retrieval and/or use by the user.

### User Interface

FIG. 7b shows an implementation of a user profile user interface in one embodiment of GCSI/CTIS operation. The profile page 760 may include a display of basic user information 763 and/or a user picture 766, and may provide a wide variety of other user information, including demographic information, interests, media libraries, friend lists, artifact scanning activities, and/or the like. The displayed implementation further includes a plurality of tabs 769 allowing the user to view profile information, edit his or her profile, view photos, groups to which the user may belong, and/or edit settings, including sharing and/or privacy settings 772. Privacy settings may, for example, control access of other individuals to a user's personal information, artifact scanning activity, and/or the like. In some implementations, certain information about a user, in particular regarding codes that a user has scanned and/or the content associated with those scans, may be shared with other users. For example, a user may be able to inquire, via a GCSI/CTIS affiliated system, as to what codes have been recently scanned by other users that are within a particular geographic radius of the user. In another example, a user scanning a code to receive a song may also be provided with information about the artifact scanning activities of other users whose codes also corresponded to songs.

In one implementation, a user may have a personal code that is associated with the user and/or a user profile. In one implementation, other users can scan the personal code to automatically join the first user's friend list. In another implementation, a personal code may comprise a short-link to the user's profile 760, and/or to other profile pages or webpages associated with the user, such as a Facebook page, Myspace page, and/or the like. In one implementation, the user can set a forwarding instruction on his or her GCSI/CTIS page to forward inquiries corresponding to scans of the user's personal code to another page. In another implementation, the user may provide the personal code on other pages as a link back to the user's GCSI/CTIS profile page.

The profile page 760 may include a display of basic user information 763 and/or a user picture 766, and may provide a wide variety of other user information, including demographic information, interests, media libraries, friend lists, code scanning activities, and/or the like. The displayed implementation further includes a plurality of tabs 769 allowing the user to view profile information, edit his or her profile, view photos, groups to which the user may belong, and/or edit settings, including sharing and/or privacy settings 772. Privacy settings may, for example, control access of other individuals to a user's personal information, code scanning activity, and/or the like. In some implementations, certain information about a user, in particular regarding codes that a user has scanned and/or the content associated with those scans, may be shared with other users. For example, a user may be able to inquire, via a GCSI/CTIS affiliated system, as to what codes have been recently scanned by other users that are within a particular geographic radius of the user. In another example, a user scanning a code to receive a song may also be provided with information about the code scanning activities of other users whose codes also corresponded to songs.

In one implementation, a user may be allowed to restrict which information of theirs is sent to other users and/or to restrict which information of other users is sent to them. For example, a user may have a “friends” list that has a different level of access than the general public.

In one implementation, a user may have a personal code that is associated with the user and/or a user profile. In one implementation, other users can scan the personal code to automatically join the first user's friend list. In another implementation, a personal code my comprise a short-link to the user's profile 760, and/or to other profile pages or webpages associated with the user, such as a Facebook page, Myspace page, and/or the like. In one implementation, the user can set a forwarding instruction on his or her GCSI/CTIS page to forward inquiries corresponding to scans of the user's personal code to another page. In another implementation, the user may provide the personal code on other pages as a link back to the user's GCSI/CTIS profile page.

In one implementation, a user may be provided recommendations in response to a code scan. For example, the user may scan a code corresponding to a particular song by a particular musical artist. The user may then be provided a listing of other songs, artists, and/or the like having codes recently scanned by the members of the user's friends list and/or that may be further related to the song and/or artist whose code the user scanned.

In one implementation, a user's code scans may be integrated with an instant messaging, blogging, micro-blogging, and/or the like service, whereby the user's code scans are automatically rendered as descriptive summaries and displayed to other users, such as on a webpage, via SMS text messages, emails, and/or the like. For example, each code scan may have a pre-set text description associated therewith that, upon scanning of the code, is displayed on a user's Twitter.com page. In one implementation, a user may receive an incentive payment for particular types of content that are provided to the user's friends, associates, blog subscribers, and/or the like as a result of the user's code scans. For example, a reward may be provided to the user every time the user scans a code corresponding to a particular brand of products and a message associated with those products is supplied to subscribers to the user's profile and/or blog. A further reward may be provided to the user if it can be determined that one of the user's associates made a purchase based on the provided message.

The privacy settings in the displayed implementation include permissions for displaying “twitters”, songs, videos, and purchases 775 associated with the user's code scans to various security levels for other people 778, including the general public, private/friends, and “snaps” (i.e., those who may have scanned a user's personal code and/or a code corresponding to the user's profile). Selection of a particular privacy setting may generate a sharing rule that is stored in association with the user and consulted each time a user scans a code corresponding to one of the categories shown at 775 to determine whether or not code-associated information should be provided and/or sent to any of the categories of people shown at 778.

The profile page 760 further includes a field 779 wherein a user may specify the location of a data storage facility to which some or all media and/or other content that the user acquires via code scans are to be sent and/or stored. For example, the user may specify an online storage facility (e.g., Apple's iDisk service) in which the user's code scan-acquired content is to be stored.

The profile page 760 further includes interface components configured to generate a personal code, in this case a JagTag 780. Selection of the button at 780 causes the GCSI/CTIS system to associate a code with the user and/or the user's profile and generate a corresponding code, which is displayed for the user. The user may then elect to save an image of the code to his or her computer desktop, send the code in an email, send the code in an MMS message, and/or the like via the interface elements at 781.

In one implementation, a user may be provided recommendations in response to a code scan. For example, the user may scan a code corresponding to a particular song by a particular musical artist. The user may then be provided a listing of other songs, artists, and/or the like having codes recently scanned by the members of the user's friends list and/or that may be further related to the song and/or artist whose code the user scanned.

In one implementation, a user's code scans may be integrated with an instant messaging, blogging, micro-blogging, and/or the like service, whereby the user's code scans are automatically rendered as descriptive summaries and displayed to other users, such as on a webpage, via SMS text messages, emails, and/or the like. For example, each code scan may have a pre-set text description associated therewith that, upon scanning of the code, is displayed on a user's Twitter.com page. In one implementation, a user may receive an incentive payment for particular types of content that are provided to the user's friends, associates, blog subscribers, and/or the like as a result of the user's code scans. For example, a reward may be provided to the user every time the user scans a code corresponding to a particular brand of products and a message associated with those products is supplied to subscribers to the user's profile and/or blog. A further reward may be provided to the user if it can be determined that one of the user's associates made a purchase based on the provided message.

In another embodiment, the GCSI/CTIS may be configured as a facility to effectuate purchases of goods and/or services. By scanning a code associated with a particular good or service, a message may be sent to a GCSI/CTIS system identifying the good or service associated with the code as well as identifying the user, such as based on a mobile device identifier. The GCSI/CTIS system may then automatically generate a bill for the user, charge a specified credit account, deduct a payment from a debit account, and/or the like to effectuate payment for the good or service. In one implementation, the GCSI/CTIS may return a payment confirmation, such as to the user's mobile device and/or a retailer's point-of-sale device to confirm that the user has provided adequate payment.

In another embodiment, the GCSI/CTIS may be configured to facilitate communications. For example, a code may correspond to a particular telephone number, IP address, and/or the like. Scanning of the code by a communications-enabled mobile device may cause the mobile device to automatically establish a connection with the address to which the code corresponds. In one implementation, the connection may be established directly by an on-board applet loaded on the mobile device. In another implementation, the connection may be established by an instruction sent to the mobile device by a GCSI/CTIS subsystem in response to a received code scan.

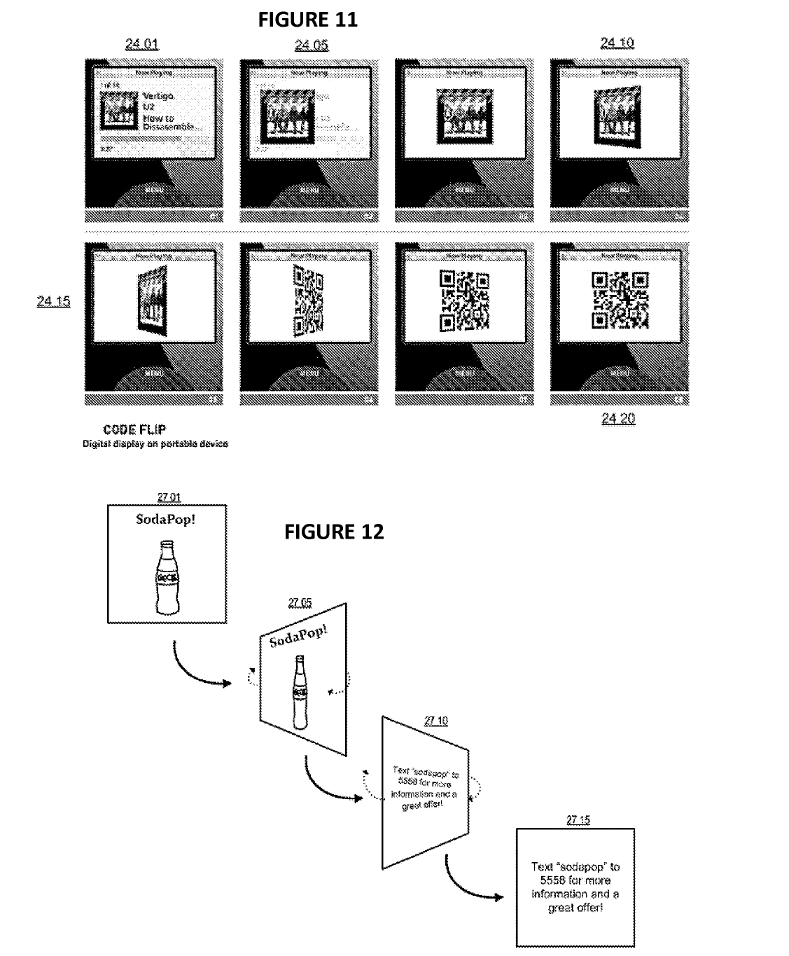

FIG. 11 shows an implementation of a user interface manifesting GCSI/CTIS functionality on a portable electronic device in one embodiment of GCSI/CTIS operation. A wide variety of different portable devices may execute and/or coordinate with GCSI/CTIS functionality, such as but not limited to portable media players, cellular telephones, blackberries, PDAs, and/or the like. In the illustrated implementation, a portable media player displays album information, including an image of the album cover, on a graphical display, where the displayed information corresponds to music being played on the player 2401. A user may click on or otherwise select the album cover image, causing it to increase in size 2405 and rotate 2410-2415 to reveal a matrix code on the image 2420.

FIG. 12 shows an implementation of a user interface manifesting GCSI/CTIS functionality for serving an SMS text message prompt in one embodiment of GCSI/CTIS operation. A first visual token 2701 shows an image and text, such as may correspond to an advertisement, logo, and/or the like. The token may appear in a wide variety of contexts, such as on a website, in a virtual world, on a cell phone or other portable communications and/or media device (e.g., Blackberry, iPhone, iPod, and/or the like), on an electronic billboard, on broadcast television or recorded video content, and/or the like. The first visual token may be animated, such as by flipping, rotating, revolving, and/or the like (2705, 2710), to reveal encoded content on a proximate side thereof. In the implementation illustrated in FIG. 12, a message appears along with an SMS code that a user may key in to an SMS enabled communication device to receive associated content. In alternative implementations, other types of codes and/or code communication protocols may be displayed and/or employed for communication with GCSI/CTIS systems, such as but not limited to: MMS, instant messaging, web browser based messaging, email, Enhanced Messaging System (EMS), TCP/IP, WAP, and/or the like. For example, a first visual token may be animated to reveal an email address, website address, instant message nickname, and/or the like on a proximate side to enable a user to connect to and/or communicate with a GCSI/CTIS system and/or affiliated entity for the receipt of information, coupons, offers, Informed Responses, media, and/or the like.

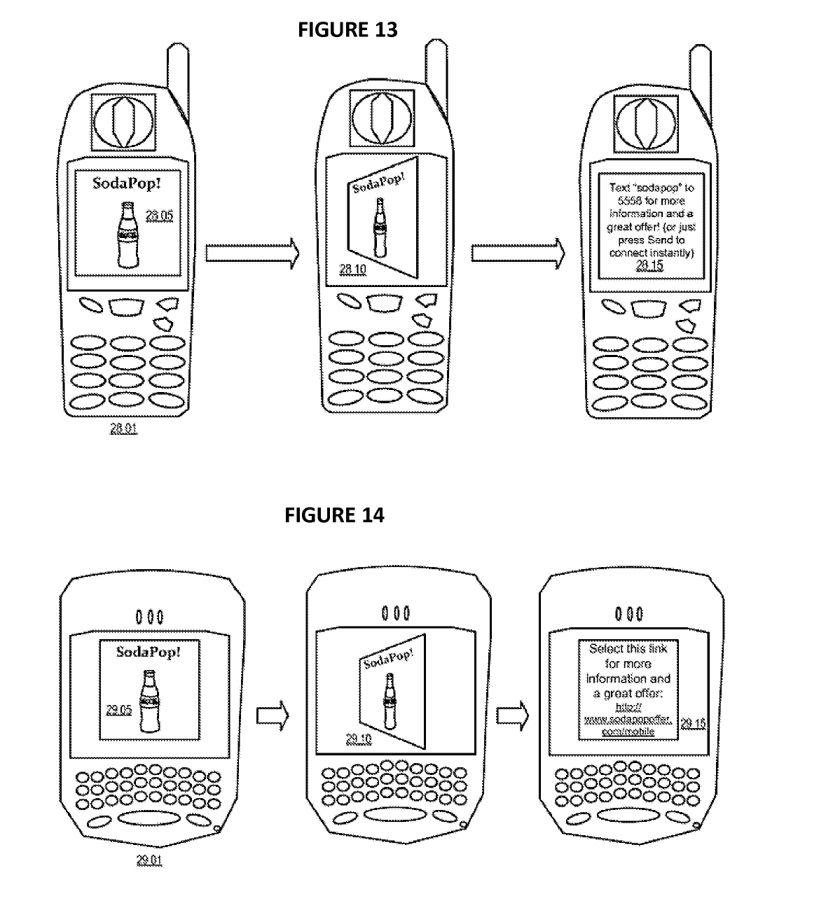

FIG. 13 shows an implementation of a user interface manifesting GCSI/CTIS functionality on a mobile phone 2801 in one embodiment of GCSI/CTIS operation. A first visual token comprising an image, advertisement, logo, and/or the like 2805 is displayed on a mobile phone display screen. The first visual token may be animated 2810, such as in response to a user interaction (e.g., pressing a button on the mobile telephone, clicking on the first visual token with a pointer widget, and/or the like). In an alternative implementation, the first visual token may be automatically animated and/or animate without the need for any user interaction. In the illustrated implementation, the animated first visual token flips to reveal a second visual token comprising a message and an SMS text message prompt on a proximate side 2815. In one implementation, the user may manually key in the text message and/or destination address to receive the associated content. In another implementation, the GCSI/CTIS interface may supply a selectable link that, when selected, will automatically generate an SMS text message to retrieve the associated content. In still another implementation, such as the example illustrated at 2815, the user may be allowed to automatically generate and/or send the SMS text message from the second visual token by pressing a “Send” button on the mobile phone, clicking and/or otherwise interacting with the second visual token, and/or the like.

In one implementation, a user may receive a coupon and/or coupon code in response to an interaction with the second visual token, sending of an SMS text and/or other message in response to the second visual token, and/or the like. For example, in one implementation, a user may receive a numerical coupon code in response to a sent SMS text message, wherein the numerical coupon code may be presented to a retailer, entered into a website, and/or the like to receive discounts, free items, special offers, and/or the like. In another implementation, the user may receive a scannable code, such as a QR code, matrix code, and/or the like in response to a sent SMS text message, wherein the scannable code may be scanned by a retailer in order for the user to receive the associated benefits, discounts, and/or the like. For example, the scannable code may appear on a user's mobile phone display screen and may be scannable therefrom to provide the user with the benefits associated thereto. In another implementation, the user may receive an e-mail message in response to interaction with a graphical code-serving interface, the message containing requested content and/or links thereto, scannable codes, coupon codes, and/or the like.

In another implementation, a first visual token may comprise a “poster” image corresponding to a full-length movie, movie preview, video clip, television show, and/or the like. The second visual token revealed on a proximate side of the first visual token may then enable a user to retrieve the full video content associated with the poster image. For example, a user may scroll through a series of poster images corresponding to a series of full-length movies. When the user finds a movie he or she desires to retrieve, watch, download, and/or the like, he or she may select the corresponding poster image, which may then be animated to reveal a second visual token, such as an SMS instruction, message, delivery address, phone number, and/or the like, whereby the user may interact with a GCSI/CTIS system and/or affiliated entity to retrieve the desired movie content.

In one implementation, a series of first visual tokens may be displayed as scrollable thumbnails, within a cinematic presentation, as an immersive slideshow, and/or the like.

FIG. 14 shows an implementation of a user interface manifesting GCSI/CTIS functionality on a portable communication device in one embodiment of GCSI/CTIS operation. The portable communication device 2901 shown in the illustrated implementation may represent a blackberry, iPhone, PDA, and/or the like. A first visual token 2905 is animated 2910 to reveal a message and a selectable hyperlink on a proximate side 2915, in this case a URL connecting to content, information, offers, coupons, and/or the like. In one implementation, a user may be permitted to directly select the hyperlink from the displayed image using interface elements of the device in order to retrieve content, view a webpage, interact with a GCSI/CTIS and/or affiliated system, and/or the like.

A variety of operational models may be employed to provide code-serving interface capabilities to users and content providers alike in accordance with the embodiments and/or implementations described herein. In one implementation, a central GCSI/CTIS server may enable content providers to supply first and/or second visual tokens, associated SMS and/or MMS codes, and/or any other information necessary to connect users to supplied content. The central GCSI/CTIS server may then outfit the supplied tokens and/or other information with HTML markup information allowing the code-serving interface to be embedded in any webpage or other display media. In one implementation, the HTML markup information may further include a link to one or more downloadable applets that may be required to enable a user to view and/or interact with the code-serving interface. Having provided the data corresponding to a first and/or second visual token, SMS and/or MMS code, and/or other information, a content provider may be provided with an embeddable link, URL, and/or the like that may be cut and pasted into a web page HTML to embed the code-serving interface therein.

In another implementation, a content provider may submit just a first visual token and response content and/or a means of addressing said content, and a GCSI/CTIS server may generate a corresponding code-serving interface, a dial-in code and/or SMS and/or MMS address, hyperlink, and/or the like to allow users to interact with the first visual token to receive the response content. In one implementation, the generated code-serving interface may include HTML markup information enabling it to be embeddable on any webpage. A fee may be charged to the content provider, such as on a pay-per-click basis, for user interactions with the generated code-serving interface.

In still another implementation, a webpage or other display area may include a generic placeholder for code-serving interfaces that may be filled by code-serving interfaces and/or associated content supplied from one or more product or service provider servers and/or GCSI/CTIS servers. The supplied code-serving interfaces may be selected based on webpage content, contextual cues, and/or the like and/or based on the goals of content providers and/or code-serving interface creators. For example, a product or service provider may wish to place a particular code-serving interface associated with a new action movie on any webpage having a generic placeholder that mentions extreme sports. A fee may be charged to a product or service provider for such targeted and/or contextual placement, such as on a bid-per-keyword basis. Fees may also be charged on a pay-per-click basis (i.e., levying a charge whenever a user clicks a code-serving interface to reveal the code, communication address, and/or the like on a proximate side).

### Coupon and Content Sharing

In another embodiment, the CTIS provides targeted coupons to consumers. By scanning a code in an article or advertisement of interest, a user may be provided with a coupon code for a store or establishment near the location where the scan took place, thereby increasing the likelihood that the coupon would be used. Choosing the coupon based on the contents of the user profile may further increase the likelihood of a consummated transaction.

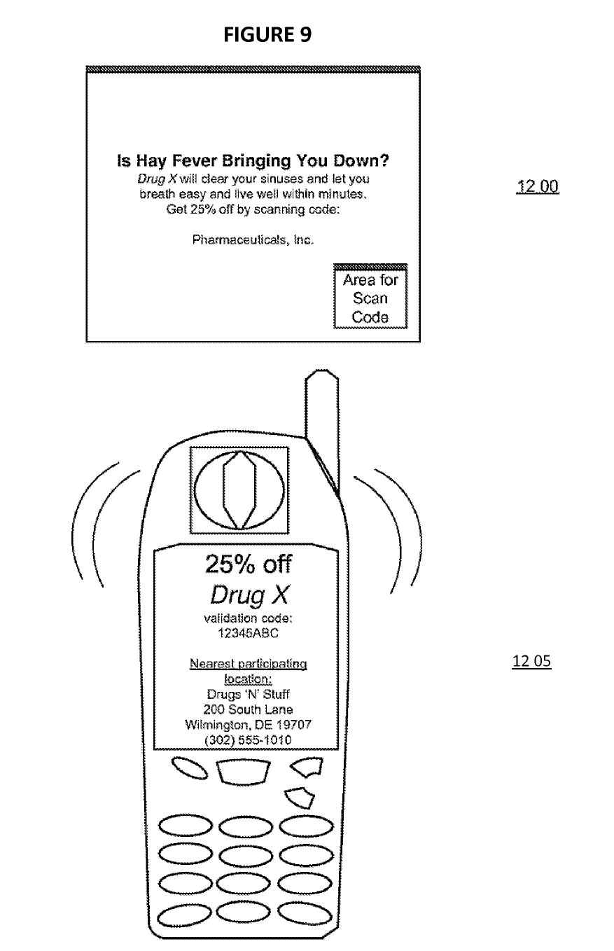

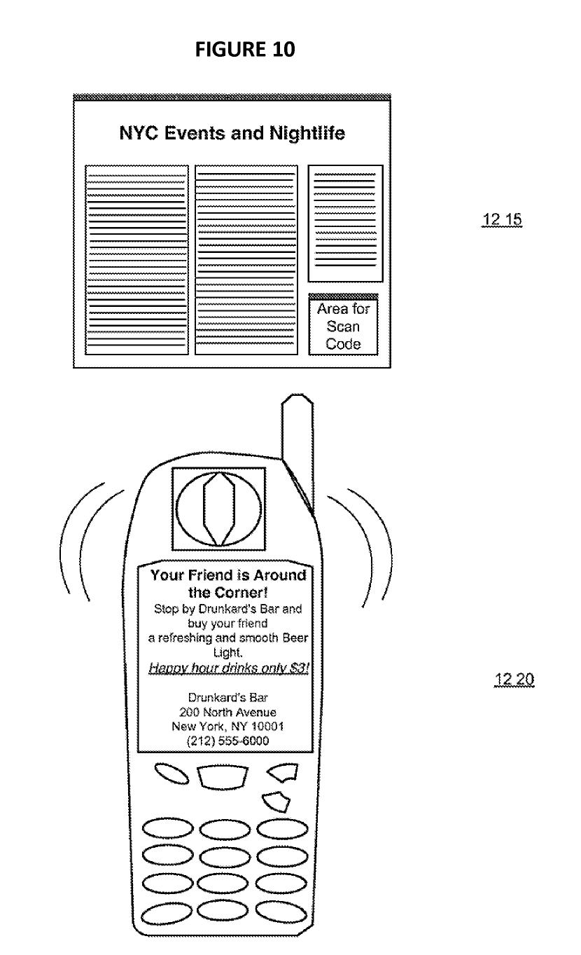

FIGS. 9 and 10 show two examples wherein the CTIS supplies coupons and/or discount info to a user. FIG. 9 shows an advertisement 1200 for hay fever medication that contains a scan code. Upon scanning the code, the user's cell phone is supplied with a coupon 1205 for 25% off the advertised medication, along with a nearby store at which to redeem the coupon. FIG. 10 shows an article related to events and nightlife in New York City 1215 that contains a scan code. Upon scanning the code to obtain additional content, the user may also be provided with a contextual advertisement for a local bar 1220, including an announcement of happy hour discount prices based on the time of the scan. In an alternative embodiment, the coupon could be provided to the user based on an anticipated provider zone breach rather than a contiguous, causal code scan.

### Application of CTIS to Product Information Gathering

In another embodiment, the CTIS can be used to provide information regarding consumer products that cannot be included on the product packaging. By scanning a artifact printed on a consumer product package, or another identifying artifact, the user could be provided with nutritional information, ingredients, website links, coupons, etc. Additional advertisements could also be served based on the nature of the product scanned and the user profile. For example, a user who scans a container of mustard and has “grilling” listed among his/her interests may be served an advertisement and/or coupon for hot dogs in addition to the mustard information.

In another embodiment, the CTIS can be used to provide product information regarding products associated with a product identified by the consumer, as shown in FIG. 16. The user initiates contact with the CTIS by performing a data capture 1605 containing at least one artifact with a data capture device. The user then includes an instruction 1610 to be sent to the CTIS server, the instruction directing the CTIS to gather specific desired product information. A Scan Message 1615 is then prepared and sent 1620 to the CTIS containing the data capture, the User ID, and the instruction. Upon receipt of the message by the CTIS, the CTIS first recognizes the Scan Message as such 1625 and validates the user associated with the User ID of the Scan Message 1630. The CTIS interprets the instruction in the Scan Message and accesses at least one Information Base 1637 and a User Profile Base 1639 to retrieve information related to a product associated with the artifact(s) included in the data capture 1635. The information retrieved from the Information Base and the User Profile Base are then evaluated 1640 to generate a Reply Message 1645 that is sent to and displayed 1650 on the data capture device.

For example, a user may identify a number of products, such as ingredients, and requests other ingredients from the CTIS to complete a recipe, suggested either by the CTIS, the user, or from any other source, such as an accessible recipe database. After comparing the ingredients provided by the user and the potential recipes using said ingredients, the CTIS can generate a Response Message comprised of one or more lists of ingredients the consumer may purchase to complete a recipe. Alternatively, the Response Message may comprise a list of recipes the user may select from, said selection triggering the creation of a further Response Message comprising a list of ingredients the consumer may purchase to complete the recipe.

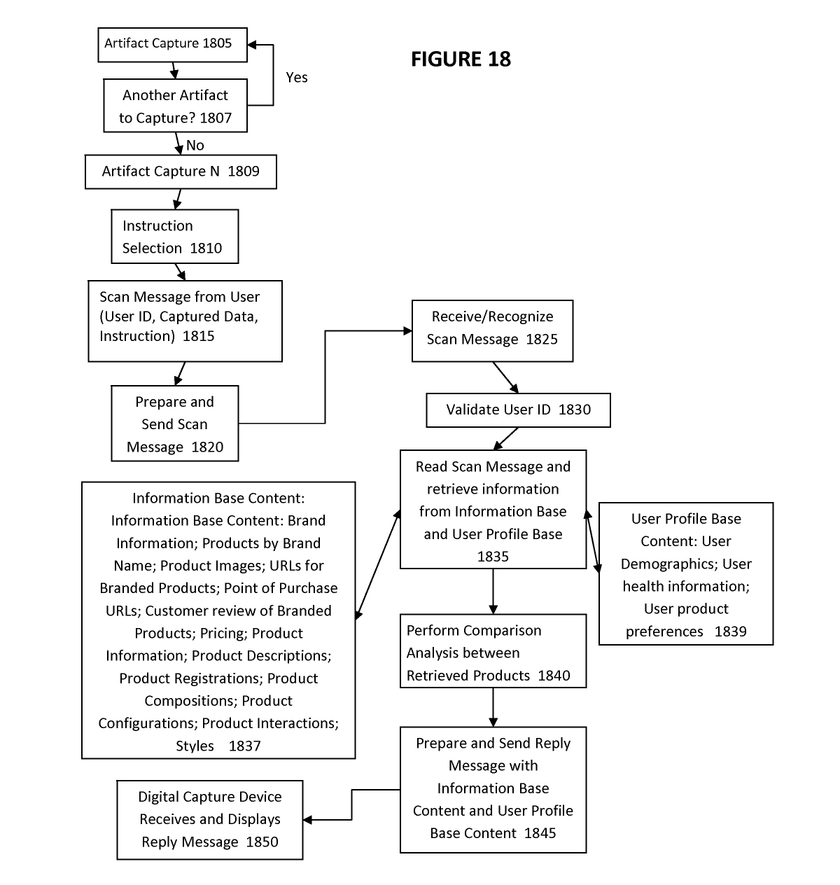

In another embodiment, illustrated in FIG. 18, the CTIS can be used to compare product information between two or more identified products. For example, the user may be deciding which of three cars to purchase. After making an appropriate web link or menu option selection, the user scans or performs an image capture of the three cars. After each image capture 1805, the user may be prompted whether there is another artifact or image to capture 1807. If yes, then the artifact capture 1805 repeats; otherwise the artifact capture halts 1809. The user then submits scans or image captures to the CTIS. The CTIS then identifies the scans or image captures by accessing a database or data store 1837 where the relevant information is maintained and identifying the cars through identifying aspects of the cars. The CTIS then accesses product information about each of the identified cars 1835, such as car manufacturer, model type, original purchase price, present market value, and model performance history, as well as information about the user from the user profile that is relevant to the user's purchasing decision, such as demographic information and geographic information. The CTIS performs a comparative analysis 1840 using the information collected and generates a Response Message 1845 comprising the best option for the user and reasons supporting that decision.

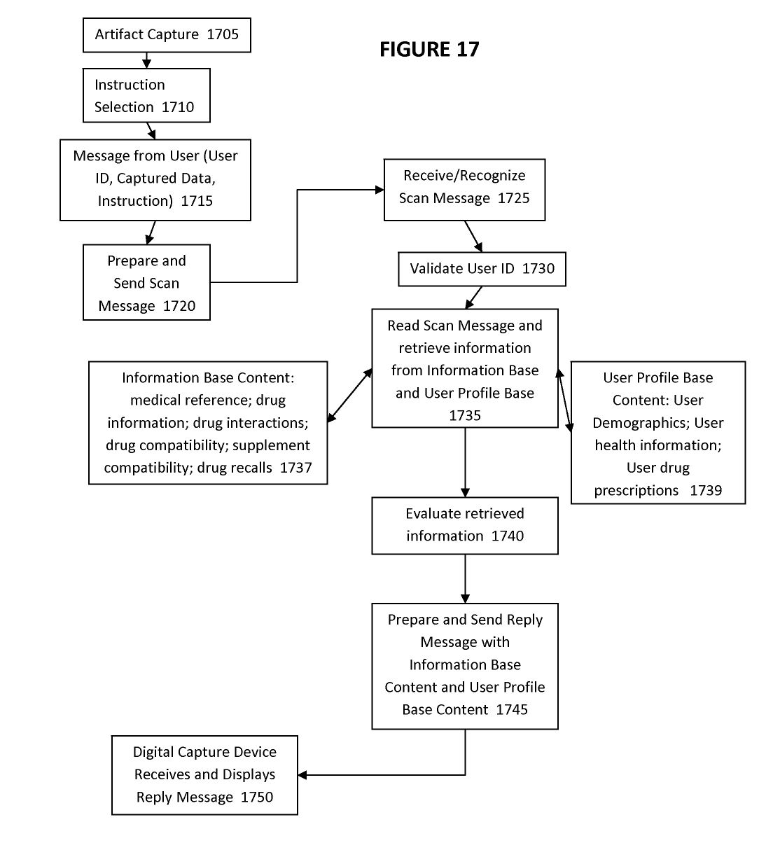

In another embodiment, illustrated in FIG. 17, the CTIS can be used to provide product information regarding aspects of an identified product. For example, the user may identify a product such as a particular sauce. However, that user may have health conditions relevant to the sauce, such as an allergy to a potential ingredient or a diet limiting sodium. These conditions are included as part of their user profile 1739. The user can request identification of potential health hazards associated with the identified product. The CTIS can access product information 1735 regarding the identified product and identify those aspects of the product that are relevant to the user's health conditions 1740. The CTIS then generates a Response Message 1745 identifying the presence or absence of health hazards. In another example, the user has configured their user profile 1739 to include a list of medications taken by the user. When considering a new medication, the user may select an appropriate web link or menu option and scan the new medication. The CTIS, in response, accesses the medications included in the user profile 1739 as well as a database of drug information 1737. The CTIS then generates a Response Message 1745 identifying potential effects the new medication may have with the medications, such as a negative interaction, currently included in the user profile.

The CTIS provides a targeted information serving system that may be applied to a wide variety of marketing and information dispensation applications. In one embodiment, the CTIS creates enhanced ads with content that cannot be included in a print ad. For example, a user who scans a code related to an automobile ad is provided additional content pertaining to the automobile such as detailed images, video, audio, reviews, and links to additional information. Based on the geocode provided in the Scan Message, the CTIS may provide a list of local dealerships and pricing. Based on the user profile, the CTIS may suggest other automobiles by the same manufacturer that are popular with customers that share the same income bracket, geographic address, number of children, etc. as the user.

In one embodiment, a method of acquiring product information comprises receiving an instruction from a user indicating a domain of interest; receiving a first message from the user identifying at least one product; retrieving user information associated with at least one of the identified products; identifying one or more supplemental products associated with at least one of the identified products; retrieving product information associated with the one or more supplemental products; composing a second message including the product information associated with the one or more supplemental products; and sending the second message to the user. The method for augmenting reality of a user having a sensory impairment, comprises the additional steps of: providing a computing device and a data capture system adapted for accepting input from and providing output to the user having sensory impairment in a form accessible to the user; capturing data corresponding to an artifact of interest to the user indicating a domain of interest from the user, in a form corresponding to the user's impaired sense; processing the captured data and formulating a first communication containing at least some of the captured data and communicating the first communication to a data repository; retrieving product information associated with the at least one identified product and the type of product information requested; retrieving user information associated with the type of product information requested; composing a message including the retrieved product information and the retrieved user information; and sending the message to the user.

The sensory impairment may comprise an impairment of at least one sensory input of visual, auditory, haptics, olfactory or gustatory. The visual sensory input may comprise at least one of visual pattern recognition, environmental or contextual recognition, text recognition, color recognition, motion detection, motion capture, motion recognition, or hand or body gestures. The auditory sensory input may comprise at least one of music, sound patterns, or natural or artificially-generated sounds. The olfactory sensory input may comprise at least one of data representing scents from foods, perfumes or colognes, environmental pollutants, ambient atmospheric scents, or gases emitted in agricultural or industrial production. The tactile sensory input may comprise at least one of data representing textiles or material surface characterization, such as that during planarizing or patterning processes. The gustatory sensory input may comprise at least one of data pertaining to relative sweetness, tartness, bitterness, spiciness, acidity, basicity or other qualities pertaining to the taste of food-stuffs.

In another embodiment, the method of promoting products or services comprise receiving an instruction from a user indicating a domain of interest; identifying the type of product or service information requested; receiving a data capture containing at least one identifying artifact; identifying at least one product associated with the at least one identifying artifact; retrieving product information associated with the at least one identified product from a product or service provider for a fee; retrieving user information associated with the user; composing a message including the retrieved product information and the retrieved user information; and sending the message to the user. The identifying artifact may comprise at least one of a pure image, an action taken by the user (such as the selection of an internet link), an RFID tag, and/or software inputs. The data capture may be received by at least one of SMS protocol, MMS protocol, instant messaging, web browser based messaging, email, Enhanced Messaging System, TCP/IP, and/or WAP. The identifying artifact may comprise at least one of products, activities, services, print, visual, electronic or audible media, barcodes, brand names, product configurations including packaging or container configurations, shapes or color combinations for products, video, body movements or gestures, olfactory scents, haptic or tactile stimuli, sound stimuli, and gustatory or taste stimuli. The message sent to the user may be communicated by at least one of SMS protocol, MMS protocol, instant messaging, web browser based messaging, email, Enhanced Messaging System, TCP/IP, or WAP.

What is claimed is:

1. A method of acquiring product information comprising the steps of:
a. receiving an instruction from a user indicating a domain of interest;
b. identifying the type of product information requested;
c. receiving a data capture containing at least one identifying artifact;
d. identifying at least one product associated with the at least one identifying artifact;
e. retrieving product information associated with the at least one identified product and the type of product information requested;
f. retrieving user information associated with the type of product information requested;
g. composing a message including the retrieved product information and the retrieved user information; and
h. sending the message to the user.

2. The method of claim 1, wherein the retrieved product information is selected from the group consisting of drug interactions, drug recalls, negative health indications, allergens, brand information, products by brand name, product images, URLs for branded products, point of purchase URLs, customer review of branded products, pricing, product information, product descriptions, product registrations, product compositions, and product configurations.

3. The method of claim 1, wherein the message further comprises information that prompts the user to take an action, prompts the user for a disposition on information provided, or provides information to the user relevant to either the at least one identified product or alternatives to the at least one identified product.

4. The method of claim 1, wherein the identifying artifact is an artifact capable of capture, comprising at least one of a barcode, a 2D code, a matrix code, a data matrix, or a QR code.

5. The method of claim 1, wherein the identifying artifact comprises at least one of a pure image, an action taken by the user (such as the selection of an internet link), an RFID tag, and/or software inputs.

6. The method of claim 1, wherein the data capture is received by at least one of SMS protocol, MMS protocol, instant messaging, web browser based messaging, email, Enhanced Messaging System, TCP/IP, and/or WAP.

7. The method of claim 1, wherein the identifying artifact comprises at least one of products, activities, services, print, visual, electronic or audible media, barcodes, brand names, product configurations including packaging or container configurations, shapes or color combinations for products, video, body movements or gestures, olfactory scents, haptic or tactile stimuli, sound stimuli, and gustatory or taste stimuli.

8. The method of claim 1, wherein the message sent to the user is communicated by at least one of SMS protocol, MMS protocol, instant messaging, web browser based messaging, email, Enhanced Messaging System, TCP/IP, or WAP.

9. A method of acquiring product information comprising the steps of:
a. receiving an instruction from a user indicating a domain of interest;
b. receiving a plurality of data captures, each data capture containing at least one identifying artifact;
c. identifying at least one product associated with each identifying artifact;
d. retrieving product information associated with each identified product;
e. retrieving user information associated with the retrieved product information;
f. performing a comparative analysis of the retrieved product information and selecting at least one of the identified products;
g. composing a message including the selected product; and
h. sending the message to the user.

10. The method of claim 9, wherein the retrieved product information is selected from the group consisting of drug interactions, drug recalls, negative health indications, allergens, brand information, products by brand name, product images, URLs for branded products, point of purchase URLs, customer review of branded products, pricing, product information, product descriptions, product registrations, product compositions, and product configurations.

11. The method of claim 9, wherein the message further comprises information that prompts the user to take an action, prompts the user for a disposition on information provided, or provides information to the user relevant to either the at least one identified product or alternatives to the at least one identified product.

12. The method of claim 9, wherein the identifying artifact is an artifact capable of capture, comprising at least one of a barcode, a 2D code, a matrix code, a data matrix, or a QR code.

13. The method of claim 9, wherein the identifying artifact comprises at least one of a pure image, an action taken by the user (such as the selection of an internet link), an RFID tag, and/or software inputs.

14. The method of claim 9, wherein the data capture is received by at least one of SMS protocol, MMS protocol, instant messaging, web browser based messaging, email, Enhanced Messaging System, TCP/IP, and/or WAP.

15. The method of claim 9, wherein the identifying artifact comprises at least one of products, activities, services, print, visual, electronic or audible media, barcodes, brand names, product configurations including packaging or container configurations, shapes or color combinations for products, video, body movements or gestures, olfactory scents, haptic or tactile stimuli, sound stimuli, and gustatory or taste stimuli.

16. The method of claim 9, wherein the message sent to the user is communicated by at least one of SMS protocol, MMS protocol, instant messaging, web browser based messaging, email, Enhanced Messaging System, TCP/IP, or WAP.

17. A method of acquiring product information comprising the steps of:
a. receiving an instruction from a user indicating a domain of interest;
b. receiving at least one data capture, the data capture containing a plurality of identifying artifacts;
c. identifying at least one product associated with each identifying artifact;
d. retrieving product information associated with each identified product;
e. retrieving user information associated with the retrieved product information;
f. performing a comparative analysis of the retrieved product information and selecting at least one of the identified products;
g. composing a message including the selected product; and
h. sending the message to the user.

18. The method of claim 17, wherein the retrieved product information is selected from the group consisting of drug interactions, drug recalls, negative health indications, allergens, brand information, products by brand name, product images, URLs for branded products, point of purchase URLs, customer review of branded products, pricing, product information, product descriptions, product registrations, product compositions, and product configurations.

19. The method of claim 17, wherein the message further comprises information that prompts the user to take an action, prompts the user for a disposition on information provided, or provides information to the user relevant to either the at least one identified product or alternatives to the at least one identified product.

20. The method of claim 17, wherein the identifying artifact is an artifact capable of capture, comprising at least one of a barcode, a 2D code, a matrix code, a data matrix, or a QR code.
